(19) United States
(12) Patent Application Publication
(10) Pub. No.: US 2006/0100949 A1
(43) Pub. Date: May 11, 2006

(54) Financial indexes and instruments based thereon

(76) Inventors: Robert E. Whaley, Chapel Hill, NC (US); Catherine T. Shalen, Chicago, IL (US); William M. Speth, Evanston, IL (US)

Correspondence Address: Paul E Schaafsma, NovuslP, LLC, Suite 221, 521 West Superior, Chicago, IL, 60610-3135, US

(21) Appl. No.: 11/238,396

(22) Filed: Sep. 29, 2005

Related U.S. Application Data
(63) Continuation-in-part of application No. 10/340,035, filed on Jan. 10, 2003.

(51) Int. Cl. G06Q 40/00

(52) U.S. Cl. 705/36 R

(57) ABSTRACT

A financial instrument in accordance with the principles of the present invention provides creating an underlying asset portfolio and implementing a passive total return strategy into the financial instrument based on writing the nearby call option against that same underlying asset portfolio for a set period on or near the day the previous nearby call option contract expires. The call written will have that set period remaining to expiration, with an exercise price just above the prevailing underlying asset price level (i.e., slightly out of the money). In one embodiment, the call option is held until expiration and cash settled, at which time a new call option is written for the set period. In another embodiment, the call option is written against the underlying asset portfolio at least thirty (30) days prior to when the call will expire and the call option is not cash-settled; whereby the financial instrument is a “qualified covered call” under the Internal Revenue Code.

### CROSS-REFERENCE TO RELATED PATENT APPLICATIONS

This application is a continuation-in-part of U.S. patent application Ser. No. 10/340,035 filed 10 Jan. 2003.

### FIELD OF THE INVENTION

The present invention relates to financial indexes and financial instruments related thereto.

### BACKGROUND OF THE INVENTION

Hedging can be defined as the purchase or sale of a security or derivative (such as options or futures and the like) in order to reduce or neutralize all or some portion of the risk of holding another security or other underlying asset. Hedging equities is an investment approach that can alter the payoff profile of an equity investment through the purchase and/or sale of options or other derivatives. Hedged equities are usually structured in ways that mitigate the downside risk of an equity position, albeit at the cost of some of the upside potential.

A buy-write hedging strategy generally is considered to be an investment strategy in which an investor buys a stock or a basket of stocks, and simultaneously sells or “writes” covered call options that correspond to the stock or basket of stocks. An option can be defined as a contract between two parties in which one party has the right but not the obligation to do something, usually to buy or sell some underlying asset at a given price, called the exercise price, on or before some given date. Options have been traded on the SEC-regulated Chicago Board Options Exchange, 400 South LaSalle Street, Chicago, Ill. 60605 (“CBOE”) since 1973. Call options are contracts giving the option holder the right to buy something, while put options, conversely entitle the holder to sell something. A covered call option is a call option that is written against the appropriate opposing position in the underlying security (such as, for example, a stock or a basket of stocks and the like) or other asset (such as, for example, an exchange traded fund or future and the like).

Buy-Write strategies provide option premium income that can help cushion downside moves in an equity portfolio; thus, some Buy-Write strategies significantly outperform stocks when stock prices fall. Buy-Write strategies have an added attraction to some investors in that Buy-Writes can help lessen the overall volatility in many portfolios. In addition to the Buy-Write strategies, other options trading strategies exist. For example, a collar is an options strategy that combines put options and call options to limit, but not eliminate, the risk that their value will decrease.

One drawback of utilizing these trading strategies is that no suitable benchmark index has existed against which a particular portfolio manager's performance could be measured. For example, even those who understand the buy-write strategy may not have the resources to see how well a particular implementation of the strategy has performed in the past. While buy-write indexes have been proposed in the prior art, these have not satisfied the market demand for such indexes. For example, Schneeweis and Spurgin, “The Benefits of Index Option-Based Strategies for Institutional Portfolios,” The Journal of Alternative Investments, 44-52 (Spring 2001), stated that “the returns for these passive option-based strategies provide useful benchmarks for the performance of the active managers studies”, thus recognizing the industry need for a buy-right index. Schneeweis and Spurgin proposed “a number of passive benchmarks” constructed “by assuming a new equity index option is written at the close of trading each day.” The option was priced by using “implied volatility quotes from a major broker-dealer.” Two strategies were employed: a “short-dated” strategy used options that expire at the end of the next day's trading; and a “long-dated strategy” involved selling (buying) a 30-day option each day and then buying (selling) the option the next day. The article noted that “these indexes are not based on observed options prices. Thus, these indexes are not directly investible.” In light of the fact that the proposed indexes in the article are not directly investible and have not been updated, the indexes utilized in this article have not gained acceptance.

Thus, what is needed is an investible index for which real financial instruments based on the functionality of the index can be created and actively traded.

In addition, a key attribute to the success of any index is its perceived integrity. Integrity, in turn, is based on a sense of fairness. For the market to perceive an index to be a “fair” benchmark of performance, the rules governing index construction must be objective and transparent. Also, it would be advantageous for the index to strike an appropriate balance between the transaction costs for unduly short-term options and the lack of premiums received from unduly long-term options. Also, it would be advantageous for the index to represent an executable trading strategy as opposed to a theoretical measure. Still further, it would be advantageous for the index to be updated and disseminated on a daily basis.

What is thus needed is a financial instrument that provides the investment community with a benchmark for measuring option over-writing performance. Such financial instrument should provide the performance of a simple, investible option overwriting trading strategy. Such financial instrument must be objective and transparent.

### SUMMARY OF THE INVENTION

A financial instrument in accordance with the principles of the present invention provides the investment community with an opportunity to obtain option buy-write performance. A financial instrument in accordance with the present invention provides the performance of a simple, investible option buy-write trading strategy. A financial instrument in accordance with the present invention is objective and transparent.

A financial instrument in accordance with the principles of the present invention provides creating an underlying asset portfolio and implementing a passive total return strategy into the financial instrument based on writing the nearby call option against that same underlying asset portfolio for a set period on or near the day the previous nearby call option contract expires. The call written will have that set period remaining to expiration, with an exercise price just above the prevailing underlying asset price level (i.e., slightly out of the money). In one embodiment, the call option is held until expiration and cash settled, at which time a new call option is written for the set period. In another embodiment, the call option is written against the underlying asset portfolio at least thirty (30) days prior to when the call will expire and the call option is not cash-settled; whereby the financial instrument is a “qualified covered call” under the Internal Revenue Code.

### BRIEF DESCRIPTION OF THE DRAWINGS

FIG. 1 sets forth the month-end total return indexes for the S&P 500® index and an example index in accordance with the principles of the present invention for the period from June 1988 through December 2001.

FIG. 2 sets forth the standardized monthly returns of the S&P 500® index and an example index in accordance with the principles of the present invention for the June 1988 through December 2001 time period.

FIG. 3 sets forth the average implied and realized volatility for the S&P 500® index options in each year 1988 through 2001.

FIG. 4 shows the cumulative value over time of a dollar invested in an example index in accordance with the principles of the present invention and other asset classes over the June 1988 to March 2004 time period.

FIG. 5 shows the compound annual rates of return of the asset classes of FIG. 4 over the June 1988 to March 2004 time period.

FIG. 6 shows the annualized standard deviations of the asset classes of FIG. 4 over the June 1988 to March 2004 time period.

FIG. 7 shows the estimated empirical density functions for both the S&P 500® index and an example index in accordance with the principles of the present invention.

FIG. 8 shows the monthly Stutzer index values of certain of the asset classes of FIG. 4 over the June 1988 to March 2004 time period.

FIG. 9 shows the expansion of the mean-variance efficient when an example index in accordance with the principles of the present invention is added to an asset mix over the June 1988 to March 2004 time period.

FIG. 10 shows the cumulative change in portfolio value during the September 2000 to September 2002 draw-down.

FIG. 11 shows the cumulative change in portfolio value during the September 1998 to March 2000 run-up.

FIG. 12 shows the call premiums earned as a percentage of the underlying value of an example index in accordance with the principles of the present invention over the June 1988 to March 2004 time period.

### DETAILED DESCRIPTION OF THE PREFERRED EMBODIMENTS

In accordance with the principles of the present invention, a series of financial instruments are created that establish benchmark indexes against which a particular portfolio manager's performance can be measured. In another embodiment, a financial instrument in accordance with the principles of the present invention leverages the financial instrument by adjusting to the desired level of risk the proportions of a long position in the underlying equity and a short position in the option for that equity

In accordance with one embodiment of the present invention, a financial instrument is created by writing a nearby, just out-of-the-money call option against the underlying asset portfolio. The call option is written in a given time period on the day the previous nearby call option contract expires. The premium collected from the sale of the call is added to the value of the financial instrument.

In this embodiment, a financial instrument was designed that invests in a portfolio of stocks that also sells covered call options in the stock of that portfolio. Such a financial instrument is a passive total return financial instrument based on writing a nearby, just out-of-the-money call option against the stock index portfolio for a given period of time, such as for example, monthly or quarterly. The call written will have approximately the same given period of time remaining to expiration, with an exercise price just above the prevailing index level. In a preferred embodiment, the call can be held until expiration and cash settled, at which time a new nearby, just out-of-the-money call can be written for that same given period of time. The premium collected from the sale of the call can be added to the total value of this financial instrument.

In this embodiment, an index was designed to reflect on a portfolio that invests in Standard & Poor's® 500 index stocks that also sells S&P 500® index covered call options (ticker symbol “SPX”). The S&P 500® index is disseminated by Standard & Poor's, 55 Water Street, New York, N.Y. 10041 (“S&P”). S&P 500® index options are offered by the Chicago Board Options Exchange®, 400 South LaSalle Street, Chicago, Ill. 60605 (“CBOE”). In an alternative embodiment, an index could be designed to reflect on a portfolio that invests in Dow Jones Industrials Average index stocks that also sells Dow Jones Industrials Average index covered call options (DJX). The Dow Jones Industrials Average index is disseminated by Dow Jones & Company Dow Jones Indexes, P.O. Box 300, Princeton, N.J. 08543-0300. Dow Jones Industrials Average index options are offered by the Chicago Board Options Exchange (CBOE). In further alternative embodiments, indexes could be designed to reflect on a portfolio that invests in NASDAQ-100 (NDX) stocks or any other equity index that also sells NASDAQ or any other equity index covered call options.

In a further alternative embodiment in accordance with the principles of the present invention, an exchange traded fund could be designed to reflect on the financial instruments that establish benchmark indexes against which a particular portfolio manager's performance can be measured. In one embodiment in accordance with the principles of the present invention, an exchange traded fund could be designed to reflect a portfolio that invests in Standard & Poor's® 500 index stocks that also sells S&P 500® index covered call options (SPX). In a still further alternative embodiment, an exchange traded fund could be designed to reflect on a portfolio that invests in Dow Jones Industrials Average index stocks that also sells Dow Jones Industrials Average index covered call options (DJX).

As known in the art, an index in accordance with the principals of the present invention can be preferably embodied as a system cooperating with computer hardware components, and as a computer-implemented method.

### EXAMPLE 1(A)

### BXM Index

As previously referenced, in one embodiment in accordance with the present invention, an index was designed to reflect on a portfolio that invests in Standard & Poor's® 500 index stocks that also sells S&P 500® index covered call options (SPX). S&P 500® index options are offered by the CBOE. Such an index can be a passive total return index based on writing a nearby, just out-of-the-money S&P 500® (SPX) call option against the S&P 500® stock index portfolio each month—usually at 10:00 a.m. Central Time on the third Friday of the month. The SPX call written will have approximately one month remaining to expiration, with an exercise price just above the prevailing index level. In a preferred embodiment, the SPX call can be held until expiration and cash settled, at which time a new, one-month, nearby, just out-of-the-money SPX call can be written. The premium collected from the sale of the call can be added to the total value of the index.

To understand the construction of the example index, the S&P 500® index return series is considered. The S&P 500® index return series makes the assumption that any daily cash dividends paid on the index are immediately invested in more shares of the index portfolio. (Standard & Poor's makes the same assumption in its computation of the total annualized return for the S&P 500® index.) The daily return of the S&P 500® index portfolio (R) can be therefore computed as:

$${R}_{St} = \frac{{S}_{1} - {S}_{t - 1} + {D}_{1}}{{S}_{t - 1}}$$

where S₁ is the reported S&P 500® index level at the close of day t, and Dₜ is the cash dividend paid on day t. The numerator contains the income over the day, which comes in the form of price appreciation, S₁−Sₜ₋₁, and dividend income, Dₜ. The denominator is the investment outlay, that is, the level of the index as of the previous day's close, Sₜ₋₁. In an alternative embodiment, an index can be constructed that measures the price return only of the S&P 500® index by excluding dividends from the calculation.

The return of an index constructed in accordance with the present invention is the return on a portfolio that consists of a long position in an equity (for example, stock) index and a short position in a call option for that equity index. In the example embodiment, the return on the index consists of a long position in the S&P 500® index and a short position in an S&P 500® call option. The daily return of an index constructed in accordance with the present invention (R) can be defined as:

$${R}_{BXM 1} = \frac{{S}_{1} + {D}_{1} - {S}_{t - 1} - ( {C}_{1} - {C}_{t - 1} )}{{S}_{t - 1} - {C}_{t - 1}}$$

where Cₜ is the reported call price at the close of day t, and all other notation are as previous defined. The numerator in this expression contains the price appreciation and dividend income of the index less the price appreciation of the call, Cₜ−Cₜ₋₁. The income on the index exceeds the equity index on days when the call price falls, and vice versa. The investment cost in the denominator of this expression can be the S&P 500® index level less the call price at the close on the previous day.

The example index constructed in accordance with the present invention was compared to the historical return series beginning Jun. 1, 1988, the first day that Standard and Poor's began reporting the daily cash dividends for the S&P 500® index portfolio, and extending through Dec. 31, 2001. The daily prices/dividends used in the return computations were taken from the following sources. First, the S&P 500® closing index levels and cash dividends were taken from monthly issues of Standard & Poor's S&P 500® index Focus Monthly Review available from Standard & Poor's, 55 Water Street, New York, N.Y. 10041. Second, the daily S&P 500® index option prices were drawn from the CBOE's market data retrieval (MDR) data file, the Chicago Board Options Exchange, 400 South LaSalle Street, Chicago, Ill. 60605.

Three types of call prices are used in the construction of the example index. The bid price can be used when the call is first written, the settlement price can be used when the call expires, and the bid/ask midpoint can be used at all other times. The bid price can be used when the call is written to account for the fact that a market order to sell the call would likely be consummated at the bid price. In this sense, the example index already incorporates an implicit trading cost equal to one-half the bid/ask spread.

In generating the history of example index returns, calls were written and settled under two different S&P 500® option settlement regimes. Prior to Oct. 16, 1992, the “PM-settlement” S&P 500® calls were the most actively traded, so they were used in the construction of the history of the example index. The newly written call was assumed to be sold at the prevailing bid price at 3:00 p.m. (Central Standard Time), when the settlement price of the S&P 500® index was being determined. The expiring call's settlement price (C) was:
C_{settle, t}=max(0, S_{settle, t}−X)
where S_{settle,t} is the settlement price of the call, and X is the exercise price. Where the exercise price exceeds the settlement index level, the call expires worthless.

After Oct. 16, 1992, the “AM-settlement” contracts were the most actively traded and were used in the construction of the history of the example index. The expiring call option was settled at the open on the day before expiration using the opening S&P 500® settlement price. A new call with an exercise price just above the S&P 500® index level was written at the prevailing bid price at 10:00 a.m. (Central Standard Time). Other than when the call was written or settled, daily returns were based on the midpoint of the last pair of bid/ask quotes appearing before or at 3:00 p.m. (Central Standard Time) each day, that is,

$${C}_{3 PM . t} \frac{{bidprice}_{3 PM} + {askprice}_{3 PM}}{2}$$

Based on these price definitions and available price and dividend data, a history of daily returns was computed for the example index for the period June 1988 through December 2001. On all days except expiration days as well as expiration days prior to Oct. 16, 1992, the daily return (R) was computed using the daily return formula previously set forth, that is:

$${R}_{BXM 1} = \frac{{S}_{1} + {D}_{1} - {S}_{t - 1} - ( {C}_{1} - {C}_{t - 1} )}{{S}_{t - 1} - {C}_{t - 1}}$$

On expiration days since Oct. 16, 1992, the daily return (R) can be computed using:
R_{BXM, t}=(1+R_{ON, t})X(1+R_{ID, t})−1
where R_{ON,t} is the overnight return of the buy-write strategy based on the expiring option, and R_{ID,t} is the intra-day buy-write return based on the newly written call. The overnight return (R) can be computed as:

$${R}_{ON , t} = \frac{{S}_{10 AM , t} + {D}_{1} - {S}_{close , t - 1} - ( {C}_{settle , t} - {C}_{close , t - 1} )}{{S}_{close , t - 1} - {C}_{close , t - 1}}$$

where S_{10Am,t} is the reported level of the S&P 500® index at 10:00 a.m. on expiration day, C_{settle,t} is the settlement price of the expiring option. The settlement price can be based on the special opening S&P 500® index level computed on expiration days and used for the settlement of S&P 500® index options and futures. Note that the daily case dividend, Dₜ, can be assumed to be paid overnight. The intra-day return (R) can be defined as:

$${R}_{ID , t} = \frac{{S}_{close , t} - {S}_{10 AM , t} - ( {C}_{close , t} - {C}_{10 AM , t} )}{{S}_{10 AM , t} - {C}_{10 AM , t}}$$

where the call prices are for the newly written option. The exercise price of the call can be the nearby, just out-of-the-money option based on the reported 10:00 a.m. S&P 500® index level.

Next, the properties of the realized monthly returns of the example index in accordance with the present invention are examined. The monthly returns were generated by linking daily returns geometrically, that is:

$${R}_{monthly} = {\prod }_{t = 1}^{{no . of days}_{i n month}} ( 1 + {R}_{daily , t} ) - 1$$

The money market rate can be assumed to be the rate of return of a Eurodollar time deposit whose number of days to maturity matches the number of days in the month. The Eurodollar rates were downloaded from Datastream, available from Thomson Financial, 195 Broadway, New York, N.Y. 10007.

Table 1 sets forth summary statistics for realized monthly returns of one-a month money market instrument, the S&P 500® index, and the example index during the period June 1988 through December 2001, where BXM represents the example index in accordance with the present invention. Table 1 shows that the average monthly return of the one-month money market instruments over the 163-month period was 0.483%. Over the same period, the S&P 500® index generated an average monthly return of 1.187%, while the example index generated an average monthly return of 1.106%. Although the monthly average monthly return of the example index was only 8.1 basis points lower than the S&P 500® index, the risk of the example index, as measured by the standard deviation of return, was substantially lower. For the example index, the standard deviation of monthly returns was 2.663%, while, for the S&P 500®, the standard deviation was 4.103%. In other words, the example index surprisingly produced a monthly return approximately equal to the S&P 500® index, but at less than 65% of the risk of the S&P 500® index (i.e., 2.663% vs. 4.103%), where risk can be measured in the usual way.

TABLE 1

| | | | | |
|---|---|---|---|---|
| | | | | Alternative |
| | | | | Buy-write |
| | Money | S&P 500 ® | BXM | Using |
| Statistic | Market | Index | Index | Midpoints |

| | | | | |
|---|---|---|---|---|
| Monthly Returns | 163 | 163 | 163 | 163 |
| Mean | 0.483% | 1.187% | 1.106% | 1.159% |
| Median | 0.467% | 1.475% | 1.417% | 1.456% |
| Standard Deviation | 0.152% | 4.103% | 2.663% | 2.661% |
| Skewness | 0.4677 | −0.4447 | −1.4366 | −1.4055 |
| Excess Kurtosis | −0.2036 | 0.7177 | 4.9836 | 4.8704 |
| Jarque-Bera Test | | | | |
| Statistic | 6.22 | 8.87 | 224.75 | 214.77 |
| Probability of Normal | 0.045 | 0.012 | 0.000 | 0.000 |
| Annual Returns | | | | |
| Mean | 5.95% | 14.07% | 13.63% | 14.34% |

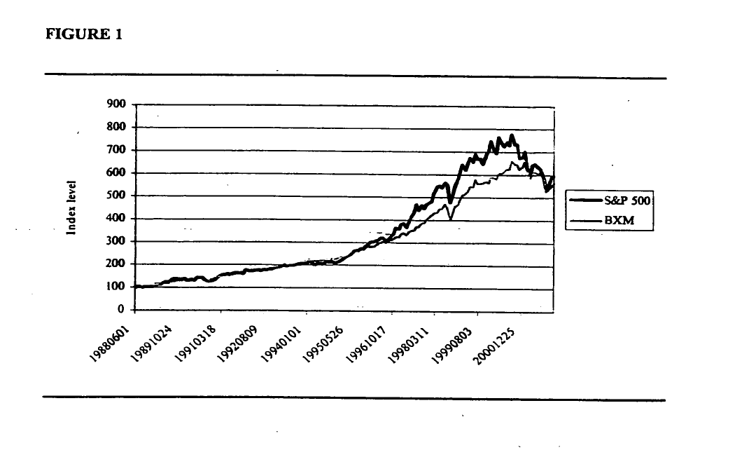

The return and risk of the example index relative to the S&P 500® index also can be seen in FIG. 1. FIG. 1 sets forth the month-end total return indexes for the S&P 500® index and the example index for the period from June 1988 through December 2001. In generating the history of the example index levels, the index was set equal to 100 on Jun. 1, 1988. The closing index level for each subsequent day was computed using the daily index return, that is:
BXMₜ=(BXMₜ₋₁)x(1+R_{BXM, t})
where BXM represents the example index. To facilitate comparing the example index with the S&P 500® index over the same period, the total return index of the S&P 500® index also was normalized to a level of 100 on Jun. 1, 1988 and plotted in FIG. 1. As FIG. 1 shows, the example index tracked the S&P 500® index closely at the outset. Then, starting in 1992, the example index began to rise faster than the S&P 500® index. but, by mid-1995, the level of the S&P 500® index total return index surpassed the example index. Beginning in 1997, the S&P 500® index charged upward in a fast but volatile fashion. The example index lagged behind, as should be expected. When the market reversed in mid-2000, the example index again moved ahead of the S&P 500® index. The steadier path taken by the example index reflects the fact that it has lower risk than the S&P 500® index. That both indexes wind up at approximately the same level after 13½ years reflects the fact that both had similar returns.

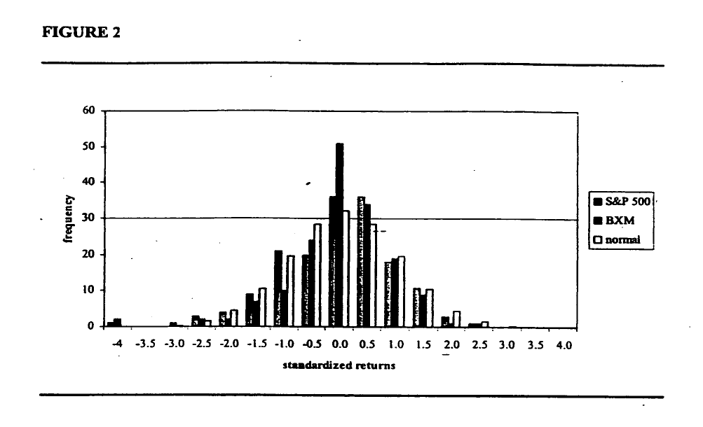

Table 1 also reports the skewness and excess kurtosis of the monthly return distributions as well as the Jarque-Bera statistic for testing the hypothesis that the return distribution is normal. Jarque and Bera, “Efficient tests for normality homoscedasticity and serial independence of regression residuals,” 6 Econometric Letters 255 (1980). Both the S&P 500® index and the example index have negative skewness. For the example index, negative skewness should not be surprising in the sense that a buy-write strategy truncates the upper end of the index return distribution. But, the Jarque-Bera statistic rejects the hypothesis that returns are normal, not only for the example index and S&P 500® index, but also for the money market rates. The negative skewness for the example index and S&P 500® index does not appear to be severe, however. FIG. 2 sets forth the standardized monthly returns of the S&P 500® index and example index in relation to the normal distribution for the period June 1988 through December 2001. The S&P 500® index and example index return distributions appear more negatively skewed than the normal, but only slightly. What stands out in FIG. 2 is that both the S&P 500® index and the example index return distributions have greater kurtosis than the normal distribution. This is reassuring in the sense that the usual measures of portfolio performance work well for symmetric distributions but not asymmetric ones.

Finally, to illustrate the degree to which writing the calls at the bid price rather than the bid/ask midpoint affected returns, the example index was re-generated assuming that the calls were written at the bid/ask price midpoint. As Table 1 shows, the average monthly return increased by about six basis points per month. The difference in annualized returns is about 70 basis points.

Next, the performance of the example index in accordance with the present invention is examined. The most commonly-applied measures of portfolio performance are the Sharpe ratio:

$$\text{Sharpe ratio} = \frac{{\overline{R}}_{p} - {\overline{R}}_{f}}{\hat{σ}}$$

(Sharpe, “Mutual Fund Performance,” 39 Journal of Business 119 (1966)); the Treynor ratio:

$$\text{Treynor Ratio} = \frac{{\overline{R}}_{p} - {\overline{R}}_{f}}{{\hat{β}}_{p}}$$

(Treynor, “How to Rate Management of Investment Funds,” 43 Harvard Business Review 63-75 (1965)); Modigliani and Modigliani's M-squared:

$$\text{M-squared} = ( {\overline{R}}_{p} - {\overline{R}}_{f} ) ( \frac{{\hat{σ}}_{m}}{{\hat{σ}}_{s}} ) - ( {\overline{R}}_{m} - {\overline{R}}_{f} )$$

(Modigliani, F and Modigliani, L, “Risk-Adjusted Performance,” Journal of Portfolio Management, 45-54 (Winter 1997)); and Jensen's alpha:
Jensen's alpha=\overline{R}ₚ−\overline{R}_{f}\hat{β}ₚ(\overline{R}ₘ−\overline{R}_{f})
Jensen, “The Performance of Mutual Funds in the Period 1945-1964,” 23 Journal of Finance 389 (1967)). All four measure are based on the Sharpe/Lintner mean/variance capital asset pricing model (Sharpe, “Capital Asset Prices: A Theory of Market Equilibrium under Conditions of Risk,” 19 Journal of Finance 425 (1964); Lintner, “The Valuation of Risk Assets and the Selection of Risky Investments in Stock Portfolios and Capital Budgets,” 47 Review of Economics and Statistics 13 (1969)). In the mean/variance capital asset pricing model, investors measure total portfolio risk by the standard deviation of returns.

In assessing ex-post performance, the parameters of the formulas are estimated from historical returns over the evaluation period. First, \overline{R}_{f}, \overline{R}ₘ and \overline{R}ₚ respectively are the mean monthly returns of a “risk-free” money market instrument, the market, and the portfolio under consideration over the evaluation period. Second, \hat{σ}ₘ and \overline{σ}ₚ are the standard deviations of the returns (“total risk”) of the market and the portfolio. Finally, \hat{β}ₚ is the portfolio's systematic risk (“beta”) estimated by an ordinary least squares, time-series regression of the excess returns of the portfolio on the excess returns of the market, that is,
R_{p,t}−R_{f,t}=αₚ+βₚ(R_{m,t}−R_{f,t})+ε_{p,t}

In addition, the risk of the example index in accordance with the present invention can be measured using Markowitz's semi-variance or semi-standard deviation as a total risk measure. (Markowitz, “Portfolio Selection,” Chapter 9 (New York: John Wiley and Sons 1959)). In the context of performance measurement, semi-standard deviation can be defined as the square root of the average of the squared deviations from the risk-free rate of interest, where positive deviations are set equal to zero, that is:

$$Total {risk}_{i} + \sqrt{{\sum }_{t = 1}^{r} {min ( {R}_{i , t} - {R}_{f , t} , 0 )}^{2}} / T$$

where i=m, p. Returns on risky assets, when they exceed the risk-free rate of interest, do not affect risk. To account for possible asymmetry of the portfolio return distribution, the total risk portfolio performance measures (a) and (b) in Table 2 is recomputed using the estimated semi-deviations of the returns of the market and the portfolio are inserted for \hat{σ}ₘ and \hat{σ}ₚ.

The systematic risk based portfolio performance measures also have theoretical counterparts in a semi-variance framework. The only difference lies in the estimate of systematic risk. To estimate the beta, a time-series regression through the origin is performed using the excess return series of the market and the portfolio. Where excess returns are positive, they are replaced with a zero value. The time-series regression specification is:
min(R_{p, t}−R_{f, t},0)=βₚ min(R_{m, t}−R_{f, t},0)+ε_{p, t}

The performance of the example index in accordance with the present invention is evaluated using the measures described above, where risk is measured using the standard deviation and the semi-standard deviation of portfolio returns. To the extent that example index returns are skewed, the measures derived from the two different models will differ. Since the standardized example index return distribution show slight negative skewness, the performance measures based on semi-standard deviation should be less than their standard deviation counterparts, but not by much. Table 2 sets forth the estimated performance measures based on monthly returns of the S&P 500® index and the example index during the period June 1988 through December 2001, where BXM represents the example index.

TABLE 2

| | | | | | | Alternative |
|---|---|---|---|---|---|---|
| | | | S&P 500 ® | BXM | BMX | Buy-write Using |
| | | Total Risk | Index | Index | Index | Theoretical Values |
| Performance Measure | Total Risk Measure | Measure | Risk | Performance | Risk | Performance |
| Total Risk Based | | | | | | |
| Sharpe Ratio | Standard Deviation | 0.172 | 0.04103 | 0.234 | 0.02663 | 0.181 |
| | Semi-Standard Deviation | 0.261 | 0.02696 | 0.331 | 0.01886 | 0.255 |
| M-Squared | Standard Deviation | | | 0.257% | | 0.040% |
| | Semi-Standard Deviation | | | 0.188% | | −0.017% |
| Systematic Risk Based | | | | | | |
| Treynor Ratio | Standard Deviation | 0.007 | 1.000 | 0.011 | 0.558 | 0.009 |
| | Semi-Standard Deviation | 0.007 | 1.000 | 0.010 | 0.622 | 0.008 |
| Jensen Alpha | Standard Deviation | | | 0.0230% | 0.558 | 0.095% |
| | Semi-Standard Deviation | | | 0.0186% | 0.622 | 0.045% |

The results of Table 2 shows the example index outperformed the S&P 500® index on a risk-adjusted basis over the investigation period. All estimated performance measures, independent of whether they are based on the mean/standard deviation or mean/semi-standard deviation frameworks, lead to this conclusion. The out-performance appears to be on order of 0.2% per month on a risk-adjusted basis. The performance results were also computed using the Bawa-Lindenberg and Leland capital asset pricing models which allow for asymmetrical return distributions. (Bawa and Lindenberg, “Capital Market Equilibrium in a Mean-Lower Partial Moment Framework,” 5 Journal of Financial Economics 189 (1977); Leland, “Beyond Mean-Variance: Performance Measurement in a Nonsymmetrical World,” Financial Analysts Journal, 27-36 (January/February 1999)). The performance results were similar to those of the mean/semi-standard deviation framework.

Second, the estimated performance measures using mean/semi-standard deviation are slightly lower than their counterparts using mean/standard deviation. The cause is the negative skewness in example index returns that was displayed in Table 1 and FIG. 2. The effect of skewness is impounded through the risk measure. In Jensen's alpha, for example, the “beta” of the example index is 0.558 using the mean/standard framework and 0.622 using the mean/semi-standard deviation framework. The skewness “penalty” is about 5 basis points per month.

In an efficiently functioning capital market, the risk-adjusted return of a buy-write strategy using S&P 500® index options should be no different than the S&P 500® index. Yet, the example index has provided a surprisingly high return relative to the S&P 500® index over the period June 1988 through December 2001. One possible explanation for this surprisingly high return is that the volatilities implied by option prices are too high relative to realized volatility. (See, for example, Stux and Fanelli, “Hedged Equities as an Asset Class,” New York: Morgan Stanley Equities Analytic Research (1990); Schneeweis and Spurgin, (2001)). In this possible explanation, there is excess buying pressure on S&P 500® index puts by portfolio insurers. (See Bollen and Whaley, “Does Price Pressure Affect the Shape of Implied Volatility Functions?” 59 Journal of Finance 711 (April 2004)). Since there are no natural counter parties to these trades, market makers must step in to absorb the imbalance. As the market maker's inventory becomes large, implied volatility will rise relative to actual return volatility, with the difference being the market maker's compensation for hedging costs and/or exposure to volatility risk. The implied volatilities of the corresponding calls also rise from the reverse conversion arbitrage supporting put-call parity.

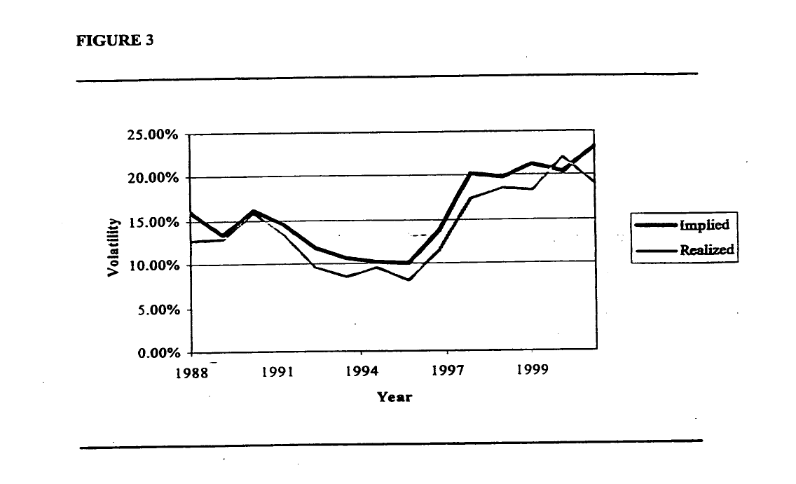

To examine whether this explanation is consistent with the observed performance of the example index, the average implied volatility of the calls written in the example index were compared to the average realized volatility over the life of the call. The implied volatility was computed by setting the observed call price equal to the Black-Scholes/Merton formula value (set forth below). (Black and Scholes, “The Pricing of Options and Corporate Liabilities,” 81 Journal of Political Economy 637 (1973); Merton, “Theory of Rational Option Pricing,” Bell Journal of Economics and Management Science, 141-183 (1973). FIG. 3 sets forth the average implied and realized volatility for the S&P 500® index options in each year 1988 through 2001. FIG. 3 shows that the difference has not been constant through time, perhaps indicating variation in the demand for portfolio insurance. The difference is persistently positive, however, with the mean (median) difference between the at-the-money (ATM) call implied volatility and realized volatility being about 167 (234) basis points on average.

To show that the high levels of implied volatility for S&P 500® index options were at least partially responsible for generating the abnormal returns of the example index, the buy-write index was reconstructed, this time using theoretical option values rather than observed option prices. The theoretical call value was generated using the Black-Scholes)/Merton formula:

$$c = ( S - PVD ) N ( {d}_{1} ) - X {ⅇ}^{- rT} N ( {d}_{2} ) where$$

$${d}_{1} = \frac{In ( ( S - PVD ) / X ) + ( r + 5 {σ}^{2} ) T}{σ \sqrt{T}} , {d}_{2} = {d}_{1} - σ \sqrt{T} ,$$

S is the prevailing index level, PVD is the present value of the dividends paid during the option's life, X is the exercise price of the call, r is the Eurodollar rate with a time to expiration matching the option, and σ is the realized volatility computed using the daily returns of the S&P 500® index over the option's one-month remaining life. The column labeled “Alternative Buy-Write Using Theoretical Values” in Table 2 contains the performance results. Although all performance measures are positive, they are all small, particularly for the theoretically superior semi-variance measures. The highest semi-variance measure is the Jensen alpha at 0.045%. Based upon the reduction in performance when theoretical values are used in place of actual prices, at least some of the risk-adjusted performance of the example index appears to arise from portfolio insurance demands.

Table 3 provides estimates of implied and realized volatility for S&P 500 options (SPX). The example index in accordance with the present invention was able to achieve good relative risk-adjusted returns over the 1989-2001 time period in part because implied volatility often was higher than realized volatility, and sellers of SPX options were rewarded because of this.

TABLE 3

| | Implied Volatility | Realized Volatility |
|---|---|---|
| 1989 | 0.13 | 0.12 |
| 1990 | 0.16 | 0.15 |
| 1991 | 0.15 | 0.14 |
| 1992 | 0.12 | 0.10 |
| 1993 | 0.11 | 0.09 |
| 1994 | 0.10 | 0.10 |
| 1995 | 0.10 | 0.08 |
| 1996 | 0.13 | 0.12 |
| 1997 | 0.19 | 0.17 |
| 1998 | 0.20 | 0.19 |
| 1999 | 0.22 | 0.18 |
| 2000 | 0.20 | 0.21 |
| 2001 | 0.24 | 0.21 |
| Average | 0.16 | 0.14 |

Table 4 provides year-end prices for the example index in accordance with the present invention and various stock price indexes from 1988 through 2001.

TABLE 4

| | | S&P 500 ® | | | | |
|---|---|---|---|---|---|---|
| | Example | Total | | | | Dow Jones |
| | Index | Return | S&P 500 ® | S&P 100 ® | Nasdaq 100 | Industrial Avg. |
| | BXM | SPTR | SPX | OEX | NDX | DJIA |
| Dec. 30, 1988 | 108.13 | 288.07 | 277.72 | 131.93 | 177.41 | 2,169 |
| Dec. 29, 1989 | 135.17 | 379.30 | 353.40 | 164.68 | 223.83 | 2,753 |
| Dec. 31, 1990 | 140.56 | 367.57 | 330.22 | 155.22 | 200.53 | 2,634 |
| Dec. 31, 1991 | 174.85 | 479.51 | 417.09 | 192.78 | 330.85 | 3,169 |
| Dec. 31, 1992 | 195.00 | 516.04 | 435.71 | 198.32 | 360.18 | 3,301 |
| Dec. 31, 1993 | 222.50 | 568.05 | 466.45 | 214.73 | 398.28 | 3,754 |
| Dec. 30, 1994 | 232.50 | 575.55 | 459.27 | 214.32 | 404.27 | 3,834 |
| Dec. 29, 1995 | 281.26 | 791.83 | 615.93 | 292.96 | 576.23 | 5,117 |
| Dec. 31, 1996 | 324.86 | 973.64 | 740.74 | 359.99 | 821.36 | 6,448 |
| Dec. 31, 1997 | 411.41 | 1298.47 | 970.43 | 459.94 | 990.80 | 7,908 |
| Dec. 31, 1998 | 489.37 | 1669.56 | 1229.23 | 604.03 | 1836.01 | 9,181 |
| Dec. 31, 1999 | 592.96 | 2021.41 | 1469.25 | 792.83 | 3707.83 | 11,497 |
| Dec. 29, 2000 | 636.81 | 1837.38 | 1320.28 | 686.45 | 2341.70 | 10,787 |
| Dec. 31, 2001 | 567.25 | 1618.99 | 1148.08 | 584.28 | 1577.05 | 10,022 |

More information on the example index is presented in Whaley, “Return and Risk of CBOE Buy Write Monthly Index,” Journal of Derivatives, 35-42 (Winter 2002); and Moran, “Stabilizing Returns With Derivatives—Risk-Adjusted Performance For Derivatives-Based Indexes,” 4 Journal of Indexes 34 (2002), the disclosures of which are incorporated herein by this reference.

In another embodiment in accordance with the present invention, a portfolio of four call options with a constant delta and time to expiration can be used. Delta refers to the amount by which an option's price will change for a one-point change in price by the underlying asset. Indeed, two or more indexes could be formed with different deltas or times to expiration. For example, an index with a delta of 0.5 and the time to expiration 30 calendar days could be formed. The first step is to identify the two nearby calls with adjacent exercise prices and deltas that straddle the underlying asset price level, and the two second nearby calls with adjacent exercise prices and deltas that straddle the underlying asset price level. The portfolio weights for the calls at each maturity are set such that the portfolio has the selected delta of 0.5. Second, the nearby and second nearby option portfolios are weighted in such a way that the weighted average time to maturity is the selected number of 30 days, thereby creating a 30-day at-the-money call. Third, the position should rebalanced at the end of each day.

### EXAMPLE 1(B)

### BXM Index II

In an additional embodiment in accordance with the present invention, an improved index was designed to reflect on a portfolio that invests in Standard & Poor's® 500 index stocks that also sells S&P 500® index covered call options (SPX). This second index is substantially the same as the first example index, with an improvement to the price at which a new call option is deemed sold. Thus, this second index likewise measures the total rate of return of a hypothetical “covered call” strategy applied to the S&P 500® index. So also, this second index consists of a hypothetical portfolio consisting of a “long” position indexed to the S&P 500® index on which are deemed sold a succession of one-month, at-the-money call options on the S&P 500® index listed on the Chicago Board Options Exchange (CBOE). This second index provides a benchmark measure of the total return performance of this hypothetical portfolio. This second index is based on the cumulative gross rate of return of the covered S&P 500® index based on the historical return series beginning Jun. 1, 1988, the first day that Standard and Poor's began reporting the daily cash dividends for the S&P 500® index.

Each S&P 500® index call option in the hypothetical portfolio is held to maturity, generally the third Friday of each month. The call option is settled against the Special Opening Quotation (or SOQ, ticker “SET”) of the S&P 500® index used as the final settlement price of S&P 500® index call options. The SOQ is a special calculation of the S&P 500® index that is compiled from the opening prices of component stocks underlying the S&P 500® index. In one embodiment, if the third Friday is a holiday, the call option will be settled against the SOQ on the previous business day and the new call option will be selected on that day as well. The SOQ calculation can be performed when all 500 stocks underlying the S&P 500® index have opened for trading, and can be usually determined before 11:00 a.m. (Eastern Time). If one or more stocks in the S&P 500® index do not open on the day the SOQ is calculated, the final settlement price for SPX options is determined in accordance with the Rules and By-Laws of the Options Clearing Corporation, One North Wacker Drive, Suite 500, Chicago, Ill. The final settlement price of the call option at maturity can be the greater of 0 and the difference between the SOQ minus the strike price of the expiring call option.

Subsequent to the settlement of the expiring call option, a new, at-the-money call option expiring in the next month is then deemed written, or sold, a transaction commonly referred to as a “roll.” The strike price of the new call option can be the S&P 500® index call option listed on the CBOE with the closest strike price above the last value of the S&P 500® index reported before 11:00 a.m. (Eastern Time). In one embodiment, if the last value of the S&P 500® index reported before 11:00 a.m. (Eastern Time) is exactly equal to a listed S&P 500® index call option strike price, then the new call option can be the S&P 500® index call option with that exact at-the-money strike price. For example, if the last S&P 500® index value reported before 11:00 a.m. (Eastern Time) is 901.10 and the closest listed S&P 500® index call option strike price above 901.10 is 905, then the 905 strike S&P 500® index call option is selected as the new call option to be incorporated into the index. The long S&P 500® index component and the short call option component are held in equal notional amounts, i.e., the short position in the call option is “covered” by the long S&P 500® index component.

Once the strike price of the new call option has been identified, the new call option can be deemed sold at a price equal to the volume-weighted average of the traded prices (“VWAP”) of the new call option during the half-hour period beginning at 11:30 a.m. (Eastern Time). In one embodiment, the VWAP can be derived in a two-step process. First, trades in the new call option between 11:30 a.m. and 12:00 p.m. (Eastern Time) that are identified as having been executed as part of a “spread” are excluded. Then the weighted average of all remaining transaction prices of the new call option between 11:30 a.m. and 12:00 p.m. (Eastern Time) are calculated, with weights equal to the fraction of total non-spread volume transacted at each price during this period. The source of the transaction prices used in the calculation of the VWAP is CBOE's MDR System. If no transactions occur in the new call option between 11:30 a.m. and 12:00 p.m. (Eastern Time), then the new call option can be deemed sold at the last bid price reported before 12:00 p.m. (Eastern Time). The value of option premium deemed received from the new call option can be functionally “re-invested” in the portfolio.

The improved example index can be calculated once per day at the close of trading for the respective components of the covered S&P 500® index. The example index can be a chained index, with its value equal to 100 times the cumulative product of gross daily rates of return of the covered S&P 500® index since the inception date of the index. On any given day, the example index (BXM) can be calculated as follows:
BXMₜ=BXMₜ₋₁(1+Rₜ)
where Rₜ is the daily rate of return of the covered S&P 500® index. This rate includes ordinary cash dividends paid on the stocks underlying the S&P 500® index that trade “ex-dividend” on that date.

On each trading day excluding roll dates, the daily gross rate of return of the index equals the change in the value of the components of the covered S&P 500® index, including the value of ordinary cash dividends payable on component stocks underlying the S&P 500® index that trade “ex-dividend” on that date, as measured from the close in trading on the preceding trading day. The gross daily rate of return (1+Rₜ) can be equal to:
1+Rₜ=(Sₜ+Divₜ−Cₜ)/(Sₜ₋₁−Cₜ₋₁)
where Sₜ is the closing value of the S&P 500® index at date t; Sₜ₋₁ is the closing value of the S&P 500® index on the preceding trading day; Divₜ represents the ordinary cash dividends payable on the component stocks underlying the S&P 500® index that trade “ex-dividend” at date t expressed in S&P 500® index points; Cₜ is the arithmetic average of the last bid and ask prices of the call option reported before 4:00 p.m. (Eastern Time) at date t; and Cₜ₋₁ is the average of the last bid and ask prices of the call option reported before 4:00 p.m. (Eastern Time) on the preceding trading day.

On roll dates, the gross daily rate of return can be compounded from: the gross rate of return from the previous close to the time the SOQ can be determined and the expiring call can be settled; the gross rate of return from the SOQ to the initiation of the new call position; and the gross rate of return from the time the new call option can be deemed sold to the close of trading on the roll date, expressed as follows:
1+Rₜ=(1+Rₐ)×(1+R_{b})×(1+R_{c})
where:
1+Rₐ=(S^{SOQ}+Divₜ−C_{Settle})/(Sₜ₋₁−Cₜ₋₁);
1+R_{b}=(S^{VWAV})/(S^{SOQ});
   and
1+R_{c}=(Sₜ−Cₜ)/(S^{VWAV}−C_{VWAP})
   where Rₐ is the rate of return of the covered S&P 500® index from the previous close of trading through the settlement of the expiring call option; R_{b} is the rate of return of the un-covered S&P 500® index from the settlement of the expiring option to the time the new call option is deemed sold; R_{c} is the rate of return of the covered S&P 500® index from the time the new call option is deemed sold to the close of trading on the roll date; C_{VWAP} is the volume-weighted average trading price of the new call option between 11:30 a.m. and 12:00 p.m. (Eastern Time); S^{SOQ} is the Special Opening Quotation used in determining the settlement price of the expiring call option; and S^{VWAV2} is the volume-weighted average value of the S&P 500® index based on the same time and weights used to calculate the VWAP in the new call option. As previously defined, Divₜ represents dividends on S&P 500® index component stocks determined in the same manner as on non-roll dates; Sₜ is the closing value of the S&P 500® index at date t; Sₜ₋₁ is the closing value of the S&P 500® index on the preceding trading day; Cₜ is the arithmetic average of the last bid and ask prices of the call option reported before 4:00 p.m. (Eastern Time) at date t; Cₜ₋₁ is the average of the last bid and ask prices of the call option reported before 4:00 p.m. (Eastern Time) on the preceding trading day; and C_{Settle} is the final settlement price of the expiring call option. Sₜ₋₁ and Cₜ₋₁ are determined in the same manner as on non-roll dates.

The improved example index is compared to five asset classes over two time periods. Initially, the period from Jun. 1, 1988 to Mar. 31, 2004, is reviewed. The asset classes used in this review are large cap equities, small cap equities, international equities, bonds, and cash. The proxies for these asset classes are, respectively, the S&P 500® index; the Russell 2000® index promulgated by Russell Investment Group, 909 A Street, Tacoma, Wash.; the MSCI® index which comprises 21 MSCI® country indices representing the developed markets outside of North America: Europe, Australasia, and the Far East, and is promulgated by Morgan Stanley Capital International Inc., 1585 Broadway, New York, N.Y.; the Lehman Brothers Aggregate Bond promulgated by Lehman Brothers, 745 Seventh Avenue, 30th Floor, New York, N.Y.; and the Ibbotson U.S. 30 Day Treasury Bill index promulgated by Ibbotson Associates, 225 North Michigan Avenue, Suite 700, Chicago, Ill.; Statistics are based on monthly total returns. (Appendix 1 presents annual returns.)

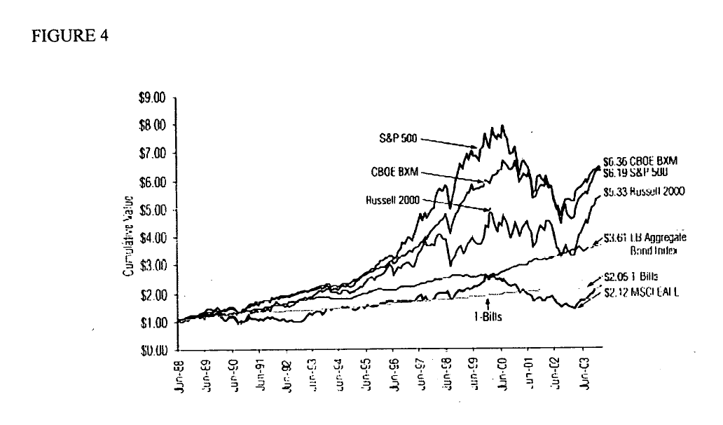

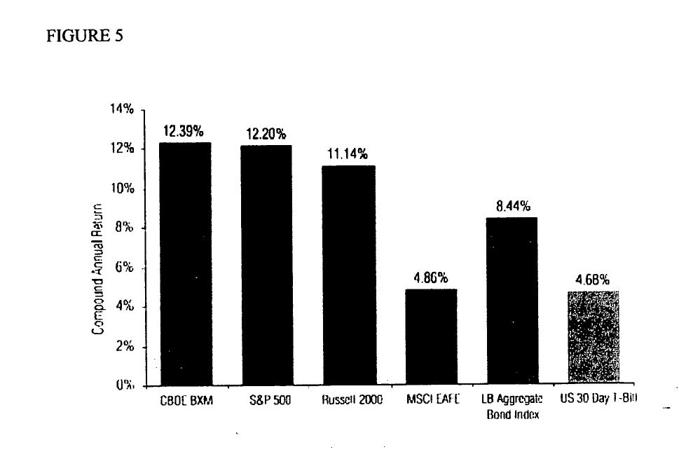

FIG. 4 shows the cumulative value over time of a dollar invested in the improved example index and all asset classes on Jun. 1, 1988. The Mar. 31, 2004 values are $6.36 for the improved example index, $6.19 for S&P 500® index, $5.33 for the Russell 2000® index, $2.12 for EAFE, $3.61 for the LB Aggregate Bond, and $2.06 for cash. In general, it can be seen that the S&P 500®0 index significantly outperformed the improved example index in the late 1990s, but lost several years of increasing relative advantage in a matter of months. FIG. 5 shows the compound annual rates of return implied by the cumulative values reported over this entire time period. Investment in the improved example index grew at an average rate of 12.39%, slightly greater than the 12.20% achieved by the S&P 500® index. All other asset classes performed significantly worse over this time period.

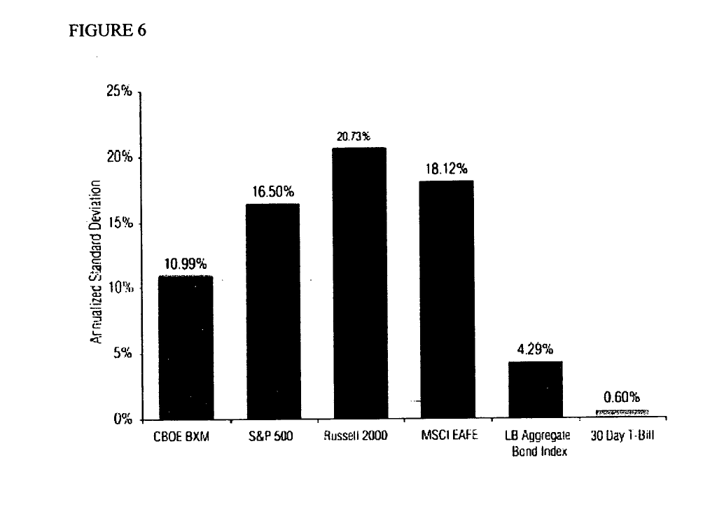

Table 5—Summary statistics for improved example index and selected asset classes, monthly data, Jun. 1, 1988 to Mar. 31, 2004—shows that that the average arithmetic returns of the improved example index, S&P 500® index, and the Russell 2000® index are quite similar over the Jun. 1, 1988 to Mar. 31, 2004 period. Returns are just over 1% per month for each, and the annualized returns range from 12.93% for the improved example index to 13.40% for the S&P 500® index. The performance of international assets over this time period is also not good. Table 5 also shows that the standard deviations are very different, running, on an annualized basis, from 10.99% for the improved example index to 20.73% for the Russell 2000® index. FIG. 6 displays standard deviations graphically. The much higher standard deviation of the Russell 2000® index explains why its cumulative performance is inferior to the improved example index and the S&P 500® index even though average returns are very similar.

TABLE 5

| | | S&P | Russell | MSCI | LB Aggr. | 30 Day |
|---|---|---|---|---|---|---|
| Statistic | BXM | 500 | 2000 | EAFE | Bond Index | T-Bill |
| Monthly Arithmetic Mean | 1.02% | 1.05% | 1.03% | 0.52% | 0.68% | 0.38% |
| Monthly Compound | 0.98% | 0.96% | 0.88% | 0.40% | 0.68% | 0.38% |
| Rate of Return | | | | | | |
| Monthly Standard Deviation | 2.83% | 4.22% | 5.31% | 4.91% | 1.15% | 1.17% |
| Excess Return | 0.64% | 0.67% | 0.64% | 0.13% | 0.30% | — |
| Monthly Sharpe ratio | 0.225 | 0.1592 | 0.1210 | 0.0273 | 0.266 | — |
| Monthly Stutzer index | 0.216 | 0.1577 | 0.1201 | 0.0273 | 0.263 | — |
| Autocorrelation | −0.012 | −0.046 | 0.125 | −0.045 | 0.151 | 0.961 |
| Skew | −1.249 | −0.456 | −0.530 | −0.111 | −0.361 | −0.050 |
| Excess Kurtosis | 3.963 | 0.609 | 1.047 | 0.321 | 0.356 | −0.426 |
| Annualized Arithmetic Mean | 12.93% | 13.40% | 13.04% | 6.38% | 8.53% | 4.68% |
| Annualized Compound | 12.39% | 12.20% | 11.14% | 4.86% | 8.45% | 4.68% |
| Rate of Return | | | | | | |
| Annualized Standard Deviation | 10.99% | 16.50% | 20.73 | 18.12% | 4.29% | 0.60% |
| Annualized Sharpe ratio | 0.752 | 0.529 | 0.402 | 0.093 | 0.907 | — |

The Sharpe Ratio is a standard measure of risk-adjusted performance. Table 5 shows that the monthly Sharpe Ratio for the improved example index is 0.225, in contrast to 0.159 for the S&P 500® index and 0.121 for the Russell 2000® index. The improved example index has the clear risk-adjusted performance advantage according to Sharpe Ratios. Table 5 implies a 42% risk-adjusted performance advantage of the improved example index over the S&P 500® index and a much greater performance advantage over the other equity asset classes.

The superior implied performance of the improved example index, based on Sharpe Ratios, however, might be biased because of the higher levels of skew and kurtosis for the improved example index reported in Table 5. The Sharpe Ratio assumes that returns are approximately normally distributed. Normormality in asset returns can lead to biased Sharpe Ratios. See generally, Till, “Life at Sharpe's end,” Risk and Reward (September 2001). Clearly, the payoff profile of the covered call strategy inclines the improved example index to negative skew and higher kurtosis. Both result naturally from the truncation of large positive returns resulting from the covered call strategy.

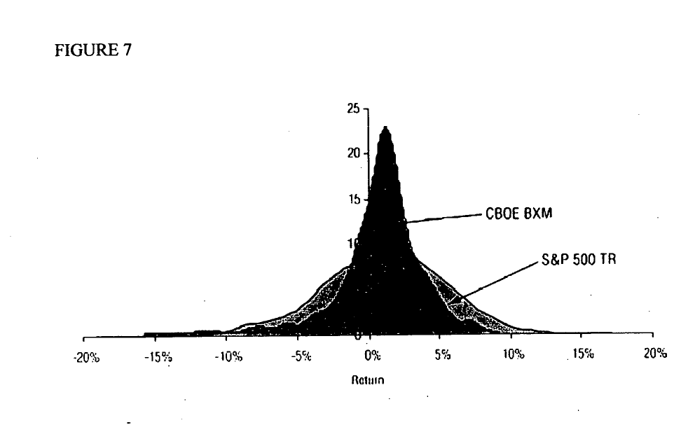

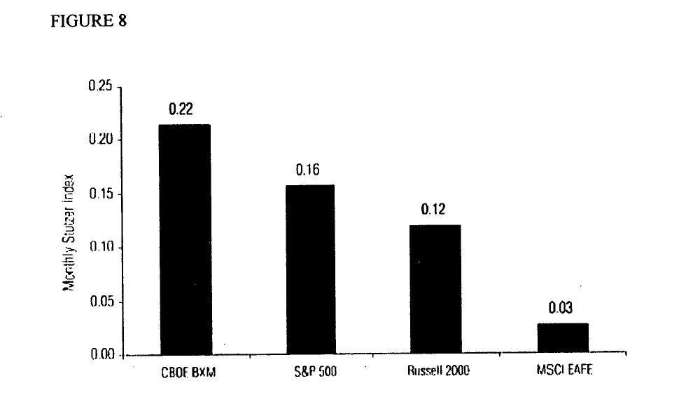

FIG. 7 shows the estimated empirical density functions for both the S&P 500® index and the improved example index. The narrower and higher density of the improved example index reflects its lower standard deviation. The larger left “tail” is indicative of the negative skew. The sharp falloff on the right tail reflects the clipped upside potential from calls that expire in-the-money. In order to obtain unbiased estimates of risk-adjusted performance, a generalization of the Sharpe Ratio is employed: the Stutzer index. Stutzer, “A portfolio performance index,” 56 Financial Analysts Journal 52 (May/June 2000). The Stutzer index provides unbiased estimates of risk-adjusted performance even when skew and kurtosis are present. The Stutzer index may be used and interpreted in the same way as the Sharpe Ratio. When the returns of an asset are normally distributed, the Stutzer index is equal to the Sharpe Ratio. Table 5 shows that the adjusted-performance advantage of the improved example index persists when using the Stutzer index to measure risk-adjusted performance. The relative performance advantage in comparison to the S&P 500® index declines from 42% to 37%, which is still a quite significant performance advantage. Stutzer index values are presented graphically in FIG. 8.

Jensen's alpha, reported in Table 5 as 2.93% per year for the improved example index, is another standard measure of risk-adjusted performance. Jensen (1967). Jensen's alpha is the return of an asset in excess of that predicted by the Capital Asset Pricing Model. Similar to the Sharpe Ratio, Jensen's alpha may be biased if returns are not approximately normally distributed. Leland's alpha remains unbiased even if returns are not normally distributed. Leland (1999). Leland's alpha is found to be 2.81% per year for the improved example index. Results based both on the Stutzer index and Leland's alpha indicate that the normormality induced by writing calls does not significantly affect improved example index risk-adjusted performance.

Next, the performance of the Rampart Investment Management investable version of the improved example index is explored. The Rampart Investment Management investable version of the improved example index is provided under license to Rampart Investment Management, One International Place, 14th Floor, Boston, Mass. Table 6—Summary statistics for Rampart BXM strategy, improved example index, and selected asset classes, Jan. 1, 2003 to Mar. 31, 2004—shows the performance of asset class benchmarks, the improved example index, and the Rampart BXM strategy over the period Jan. 1, 2003 to Mar. 31, 2004. All performance is reported on a before-fee basis. Over this period, the S&P 500® index outperforms the improved example index and the Rampart BXM strategy. On an annualized basis, the S&P 500® index gained 24.63% with a standard deviation of 13.04%. The Rampart BXM strategy investable index returned an annualized 17.26% at a 9.04% standard deviation. The improved example index performance is very similar. The Sharpe Ratios show the S&P 500® index with a small risk-adjusted performance advantage (3.74%) against the Rampart BXM strategy.

TABLE 6

| | Rampart | | S&P | Russell | MSCI | LB Aggr. | 30 Day |
|---|---|---|---|---|---|---|---|
| Statistic | BXM | BXM | 500 | 2000 | EAFE | Bond Index | T-Bill |
| Monthly Arith. Mean | 1.34% | 1.32% | 1.85% | 3.11% | 2.59% | 0.45% | 0.08% |
| Monthly Compound | 1.31% | 1.30% | 1.81% | 3.03% | 2.52% | 0.44% | 0.08% |
| Rate of Return | | | | | | | |
| Monthly Standard Dev. | 2.25% | 2.31% | 3.07% | 4.25% | 3.80% | 1.37% | 0.01% |
| Excess Return | 1.25% | 1.24% | 1.77% | 3.03% | 2.50% | 0.37% | — |
| Monthly Sharpe ratio | 0.556 | 0.535 | 0.557 | 0.712 | 0.658 | 0.271 | — |
| Monthly Stutzer index | 0.645 | 0.628 | 0.641 | 0.784 | 0.698 | 0.266 | — |
| Autocorrelation | −0.19 | −0.22 | 0.12 | 0.19 | −0.23 | −0.06 | 0.46 |
| Skew | 1.11 | 1.21 | 0.58 | 0.32 | 0.16 | −1.42 | 0.01 |
| Excess Kurtosis | 1.79 | 1.80 | −0.21 | −0.68 | −0.07 | 3.92 | −1.51 |
| Annualized Arith. Mean | 17.26% | 17.05% | 24.63% | 44.43% | 35.87% | 5.57% | 1.00% |
| Annualized Compound | 16.95% | 16.71% | 24.02% | 43.08% | 34.84% | 5.46% | 0.99% |
| Rate of Return | | | | | | | |
| Annualized Standard Deviation | 9.04% | 9.27% | 13.04% | 20.72% | 17.52% | 4.97% | 0.05% |
| Annualized Sharpe ratio | 1.797 | 1.730 | 1.812 | 2.094 | 1.990 | 0.921 | — |

Table 7 reports monthly performance before expenses. The monthly tracking error is 0.37%, which annualizes to 1.28%. While this is greater than the tracking of well-managed index funds, it is at the lower range of tracking error for enhanced index funds. See generally, Frino and Gallagher, “Tracking S&P 500 Index funds,” 28 Journal of Portfolio Management 44 (Fall 2001). Interestingly, this period was a period of positive skew in the S&P 500® index, but of greater positive skew for the improved example index covered call index. As a result, when measuring performance by the Stutzer index, the Rampart BXM strategy has a slender (0.7%) performance advantage over the S&P 500® index. Even in an upward trending market where the covered call strategy is at a natural disadvantage, the improved example index still does very well on a risk-adjusted basis. Note also, the levels of autocorrelation reported for the improved example index in Tables 5 and 6 are low. The level of autocorrelation is important in inferring long-term risk. High positive autocorrelation implies understated long term volatilities that require adjustment. See Lo, “The Statistics of Sharpe Ratios,” 58 Financial Analysts Journal 36 (July/August 2002). The levels of autocorrelation observed here do not indicate significant levels of bias.

TABLE 7

| | Rampart | |
|---|---|---|
| | BXM | BXM |
| January 03 | −0.40% | −0.52% |
| February 03 | −0.77% | −0.80% |
| March 03 | −0.18% | 0.03% |
| April 03 | 7.07% | 7.18% |
| May 03 | 2.26% | 1.70% |
| June 03 | −0.66% | −0.43% |
| July 03 | 2.36% | 2.47% |
| August 03 | 2.96% | 2.87% |
| September 03 | −1.86% | −1.87% |
| October 03 | 4.11% | 4.63% |
| November 03 | 1.43% | 1.21% |
| December 03 | 1.16% | 1.72% |
| January 04 | 1.33% | 0.44% |
| February 04 | 1.32% | 1.33% |
| March 04 | −0.09% | −0.14% |

The practical benefits of potential investments are best understood in the context of an investor's portfolio. This is the best way that the diversification potential of an investment can be properly understood. The impact of adding the improved example index to three standard investor portfolios is reviewed. These portfolios are shown in Table 8 and are recommended by Ibbotson Associates to long-term investors investing in the five basic asset classes discussed herein. There is a conservative, moderate, and aggressive portfolio. The conservative portfolio is 20% equity, the moderate portfolio is 60% equity, and the aggressive portfolio is 95% equity.

TABLE 8

| Asset Class | Conservative | Moderate | Aggressive |
|---|---|---|---|
| Large Cap Stocks | 15% | 35% | 50% |
| Small Cap Stocks | 0% | 9% | 17% |
| International Stocks | 5% | 16% | 28% |
| Bonds | 47% | 30% | 0.49% |
| Cash Equivalent | 0.24% | 0.40% | 0.49% |

Table 9—Standard Ibbotson Associates consulting portfolios (monthly rebalance June 1988 to March 2004)—shows the performance of these portfolios over the Jun. 1, 1988 to Mar. 31, 2004 review period. These results are consistent with market performance over this period. Table 10—Ibbotson Associates portfolios with 15% BXM (monthly rebalance June 1988 to March 2004)—shows the performance of the three model portfolios with allocations to large cap replaced with 15% allocation to the improved example index. The annualized return for the conservative portfolio drops seven basis points, from 7.85% to 7.78%, as the entire 15% allocation to large cap is replaced with the improved example index. The annualized standard deviation drops 73 basis points, from 3.92% to 3.19%. The annualized Sharpe Ratio increases from 0.818 to 0.988. The Sharpe Ratio, however, does not take account of the modest observed increases in negative skew and excess kurtosis. The monthly Stutzer index does. The Stutzer index rises from 0.237 to 0.283, a change very similar to the change in the monthly Sharpe Ratio.

TABLE 9

| | Conservative | Moderate | Aggressive |
|---|---|---|---|
| Monthly Mean | 0.63% | 0.79% | 0.88% |
| Monthly Standard Deviation | 1.06% | 2.50% | 3.86% |
| Excess Return | 0.25% | 0.40% | 0.50% |
| Monthly Sharpe ratio | 0.239 | 0.162 | 0.129 |
| Monthly Stutzer index | 0.237 | 0.160 | 0.127 |
| Autocorrelation | −0.020 | −0.004 | 0.018 |
| Skew | −0.163 | −0.545 | −0.634 |
| Excess Kurtosis | 0.009 | 0.660 | 0.969 |
| Annualized Mean | 7.85% | 9.97% | 11.09% |
| Annualized Standard Deviation | 3.92% | 9.47% | 14.79% |
| Annualized Sharpe ratio | 0.818 | 0.547 | 0.432 |

TABLE 10

| | Conservative | Moderate | Aggressive |
|---|---|---|---|
| Monthly Mean | 0.63% | 0.78% | 0.87% |
| Monthly Standard Deviation | 0.86% | 2.26% | 3.62% |
| Excess Return | 0.24% | 0.40% | 0.49% |
| Monthly Sharpe ratio | 0.289 | 0.177 | 0.136 |
| Monthly Stutzer index | 0.283 | 0.173 | 0.134 |
| Autocorrelation | 0.016 | 0.001 | 0.022 |
| Skew | −0.386 | −0.725 | −0.753 |
| Excess Kurtosis | 0.162 | 1.130 | 1.327 |
| Annualized Mean | 7.78% | 9.80% | 11.02% |
| Annualized Standard Deviation | 3.19% | 8.56% | 13.87% |
| Annualized Sharpe ratio | 0.988 | 0.597 | 0.456 |

The results for the Ibbotson moderate and aggressive portfolios show a repetition of the patterns observed for the conservative portfolio. There are under 10 basis point declines in annualized return coupled with approximately 90 basis point declines in annualized volatility. This results in an increase in risk-adjusted performance, whether measured by the Sharpe Ratio or the Stutzer index.

Performance over the period Jan. 1, 2003 to Mar. 31, 2004, the complete history of the Rampart investable BXM index, is considered. Table 11—Ibbotson Associates portfolios and with 15% of BXM (monthly rebalance June 1988 to March 2004) and Table 12—Ibbotson Associates conservative portfolio and with 15% of BXM or Rampart BXM strategy substituted for large cap (monthly rebalance January 2003 to March 2004)—report the performance of the conservative and aggressive Ibbotson consulting portfolios and the effect of adding 15% improved example index and the Rampart BXM strategy to these portfolios. Over this period, the decline in return is much greater than over the complete history. This is not surprising given the very strong performance of equity assets over this period.

TABLE 11

| | | 15% Covered Call | |
|---|---|---|---|
| Statistic | Baseline | Rampart | BXM |
| Monthly Mean | 0.63% | 0.78% | 0.87% |
| Monthly Standard Deviation | 0.86% | 2.26% | 3.62% |
| Excess Return | 0.24% | 0.40% | 0.49% |
| Monthly Sharpe ratio | 0.289 | 0.177 | 0.136 |
| Monthly Stutzer index | 0.283 | 0.173 | 0.134 |
| Autocorrelation | 0.016 | 0.001 | 0.022 |
| Skew | −0.386 | −0.725 | −0.753 |
| Excess Kurtosis | 0.162 | 1.130 | 1.327 |
| Annualized Mean | 7.78% | 9.80% | 11.02% |
| Annualized Standard Deviation | 3.19% | 8.56% | 13.87% |
| Annualized Sharpe ratio | 0.988 | 0.597 | 0.456 |

TABLE 12

| | | 15% Covered Call | |
|---|---|---|---|
| Statistic | Baseline | Rampart | BXM |
| Monthly Mean | 0.65% | 0.57% | 0.57% |
| Monthly Standard Deviation | 0.89% | 0.75% | 0.75% |
| Excess Return | 0.56% | 0.49% | 0.48% |
| Monthly Sharpe ratio | 0.631 | 0.647 | 0.650 |
| Monthly Stutzer index | 0.651 | 0.652 | 0.659 |
| Autocorrelation | 0.144 | 0.075 | 0.060 |
| Skew | −0.088 | −0.268 | −0.241 |
| Excess Kurtosis | 0.146 | 0.733 | 0.765 |
| Annualized Mean | 8.05% | 7.06% | 7.03% |
| Annualized Standard Deviation | 3.33% | 2.78% | 2.75% |
| Annualized Sharpe ratio | 2.120 | 2.181 | 2.191 |

Table 13—Ibbotson Associates aggressive portfolio and with 15% of BXM or Rampart BXM strategy substituted for large cap (monthly rebalance January 2003 to March 2004)—shows the results for conservative portfolios. Annualized return drops approximately 100 basis points. Annualized standard deviation, however, drops by more than 50 basis points. By all indicators, the risk-adjusted return of the conservative portfolio still increases with the addition of the improved example index. The risk-adjusted return of portfolios with the improved example index is slightly better than the performance of portfolios with Rampart BXM strategy. This result is interesting as Table 8 shows the Rampart BXM strategy has slightly better mean and standard deviation and risk-adjusted performance compared to the improved example index.

TABLE 13

| | | 15% Covered Call | |
|---|---|---|---|
| Statistic | Baseline | Rampart | BXM |
| Monthly Mean | 2.20% | 2.12% | 2.12% |
| Monthly Standard Deviation | 3.15% | 2.99% | 2.99% |
| Excess Return | 2.12% | 2.04% | 2.04% |
| Monthly Sharpe ration | 0.672 | 0.684 | 0.681 |
| Monthly Stutzer index | 0.741 | 0.760 | 0.757 |
| Autocorrelation | 0.234 | 0.209 | 0.200 |
| Skew | 0.438 | 0.501 | 0.501 |
| Excess Kurtosis | −0.172 | −0.021 | −0.023 |
| Annualized Mean | 29.87% | 28.70% | 28.66% |
| Annualized Standard Deviation | 13.91% | 13.06% | 13.10% |
| Annualized Sharpe ratio | 2.075 | 2.119 | 2.111 |

The drop in annualized return for the aggressive portfolio is more than 110 basis points and the decline in annualized volatility is about 80 basis points. Again, risk adjustment by either measure indicates an increase in risk-adjusted return with the addition of either the improved example index or the Rampart BXM strategy. The year 2003 was the first year of positive S&P 500® index returns since 1999. The years 2000 through 2002 were the longest string of consecutive large cap losses since 1941, and only the great depression itself produced a longer string of losses in the record of S&P performance (cumulative losses 1929-1932: 64.22%, 1939-1941 20.57%, and 2000-2002 37.61%). It is hard to imagine a tougher environment than 2003 for the covered call strategy.

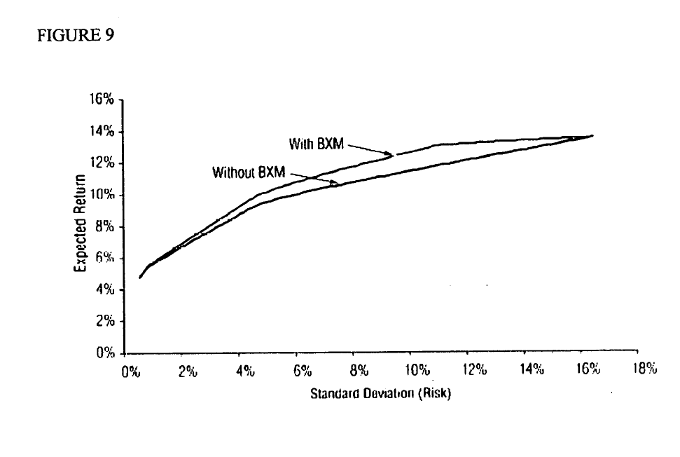

FIG. 9 presents the mean-variance efficient frontiers based on the 1998 to 2004 time period. The inner frontier is generated by using only conventional assets. The outer frontier results from the addition of the improved example index. It can be seen that the improved example index significantly expands the efficient frontier. The skew and kurtosis of the improved example index indicate that the mean-variance frontier may somewhat overestimate the expansion of the true efficient frontier; however, the relatively close agreement of the Sharpe Ratio and Stutzer index suggest that this overestimation is relatively small.

The realization of these performance gains is dependent on having, in some cases, very large levels of BXM holdings. Sensitivity studies were conducted with the improved example index returns reduced by 100, 200, and 300 basis points. Allocations did not change appreciably with a 100 basis point reduction in return, strongly suggesting that neither taking expenses into account nor some decline in future relative performance would alter the basic pattern of results described here. A 200 basis point reduction in the improved example index performance led to inclusion of up to 16% improved example index in optimal portfolios. Even after a 300 basis point reduction in the improved example index performance, a 6% allocation to the improved example index was found to be optimal for more conservative investors.

The BXM covered call index forgoes upside potential above the strike price in return for the downside cushion of the call premium. The strategy should be expected to enhance returns in bear markets, but lower returns during bull markets. The performance of the improved example index and its effects on investor portfolios during market upturns and downturns is examined as defined by the performance of the S&P 500® index. Looking at market downturns helps in the assessment of the efficacy of the covered call strategy in providing downside cushion. The review of market upturns provides insight into the extent of the truncation of upside potential. Two separate definitions of market upturns and downturns can be used.

Under the first definition, a market downturn is identified as any month where the S&P 500® index returned −2.0% or less. That is, the improved example index and portfolio performance statistics were generated conditional on the S&P 500® index returning −2.0% or less during the month. Conversely, a bull market or upswing is defined as the S&P 500® index returning 2.0% or more during the month.

Table 14-41 Months over the period June 1988 to March 2004 when the S&P 500® index TR was down 2% or more—shows that between June 1988 and March 2004 there were 41 months when the S&P 500® index returned −2% or less.

TABLE 14

| | Arithmetic | Standard |
|---|---|---|
| | Mean (%) | Deviation (%) |
| BXM TR | −2.54 | 3.09 |
| S&P 500 ® Index TR | −4.86 | 2.75 |
| Conservative | −0.70 | 0.67 |
| Conservative with 15% BXM | −0.35 | 0.71 |
| Aggressive | −4.37 | 3.00 |
| Aggressive with 15% BXM | −4.02 | 3.00 |

The monthly arithmetic mean return over those 41 months for the S&P 500® index was −4.9%, whereas the arithmetic mean return for the improved example index over the same 41 months was −2.5%. On average, about 230 basis points less was lost with the covered call strategy than with the S&P 500® index, albeit, perhaps surprisingly, with slightly higher standard deviation. This result is reflected in the model portfolios where the portfolios with a 15% allocation to the improved example index lost about 35 basis points less on average than the model portfolios without the improved example index during these periods. The monthly standard deviation of conservative portfolios with the improved example index during these months was 0.71%, as compared to 0.57% for the standard conservative portfolio. During the same period there were 81 months when the S&P 500® index returned 2% or more (bull market). Table 15-81 Months over the period June 1988 to March 2004 when the S&P 500® index TR was up by 2% or more—shows that, on average, the S&P 500® index outperformed the improved example index by about 182 basis points per month over these 81 months.

TABLE 15

| | Arithmetic | Standard |
|---|---|---|
| | Mean (%) | Deviation (%) |
| BXM TR | 2.95 | 1.69 |
| S&P 500 ® Index TR | 4.77 | 2.14 |
| Conservative | 1.46 | 0.68 |
| Conservative with 15% BXM | 1.18 | 0.59 |
| Aggressive | 3.96 | 2.14 |
| Aggressive with 15% BXM | 3.69 | 1.99 |

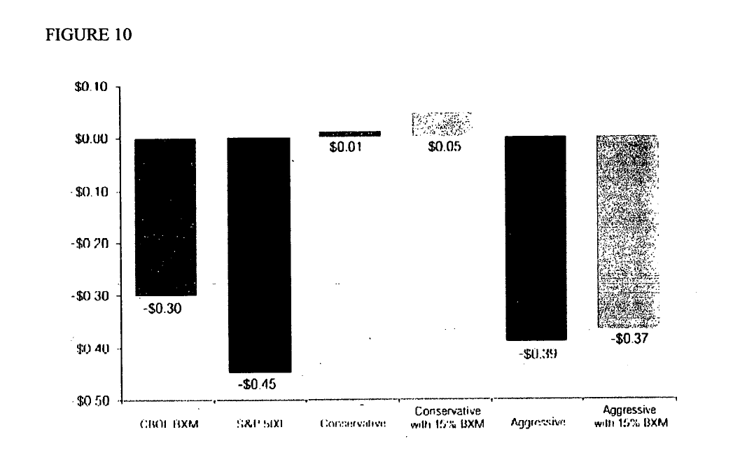

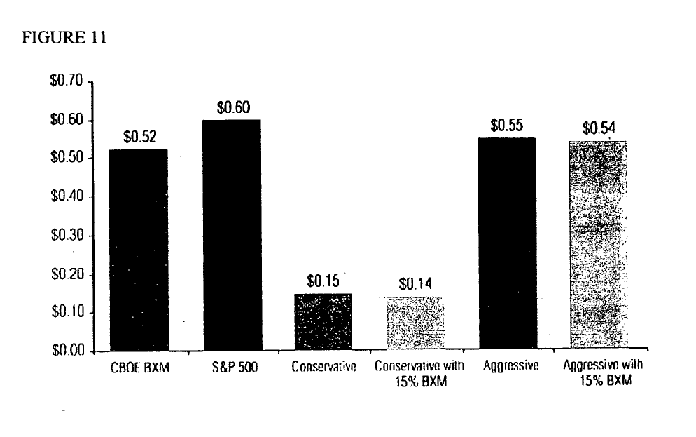

The second definition identifies bull and bear markets by the magnitude of the draw-down or run-up. A single large run-up and draw-down are identified as representative of bull and bear markets, respectively. The largest draw-down is identified as the period from September 2000 to September 2002, when the S&P 500® index declined 44.7%. The period from September 1998 to March 2000 is identified as one of the largest run-ups when the S&P 500® index rose almost 60%. FIGS. 10 and 11 are directed to these time periods.

The results in FIG. 10 confirm that the covered call strategy provides significant downside protection during bear markets. Over the 25 months of the draw down, the S&P 500® index had a compound return of −2.3% per month. The improved example index performance was about 90 basis points better, with a monthly compound return of −1.4%. This translates to a cumulative loss of about 15 cents less on the dollar vis-à-vis the S&P 500® index (see FIG. 10). Consequently, the conservative portfolio with a 15% allocation to the improved example index had a cumulative gain of about four cents more on the dollar than the regular conservative portfolio, and the aggressive portfolio with 15% improved example index had a cumulative loss of about two cents less on the dollar than the aggressive portfolio without the improved example index.

The results for the 19 months of the bull market from September 1998 to March 2000 show that the compound average return on a monthly basis for the S&P 500® index was approximately 2.5% as opposed to 2.25% for the improved example index. This translates to a cumulative gain of about eight cents less vis-à-vis the S&P 500® index over the entire 19 months (see FIG. 11). Consequently, the portfolios with 15% improved example index gain about one cent less on a cumulative basis than the portfolios without the improved example index. The results developed here demonstrate that a modest investment in the improved example index would have provided a significant improvement in risk-adjusted return for typical investor portfolios and that investable versions of the improved example index should have been able to deliver the performance of the improved example index.

Next, some issues relevant to whether the relative performance of the improved example index should be expected to continue in the future are reviewed. The value of covered-call investment strategies has been studied by practitioners (See, for example, Hill and Gregory, “Covered Call Strategies on S&P 500 Index Funds: Potential Alpha and Properties of Risk-Adjusted Returns,” Goldman Sachs Research (2003); Moran (2002); Stux and Fanelli (1990)) and academics. Many academic studies that assume options are priced according to the Black Scholes model find little or no risk-adjusted performance gain. (Merton, Scholes, and Gladstein, “The returns and risk of alternative call option portfolio investment strategies,” 51 Journal of Business 183 (1978) use simulation based on Black Scholes pricing and find potential benefits to covered call investing.)

Rendleman, “Covered call writing from an expected utility perspective,” The Journal of Derivatives, 63-75 (Spring 2001) finds only narrow conditions under which an investor's risk preferences will cause them to write calls when options are priced according to Black Scholes. Leland (1999) shows that a covered call strategy implemented with Black Scholes priced options has zero adjusted Leland's alpha. This literature might seem to call into question the value of options; however, recent studies based on actual options prices have found that option writing can be very profitable. See, particularly, Bollen and Whaley (2004), and Bondarenko, “Why are put options so expensive?” Chicago: University of Illinois at Chicago (2003) available at ssm.com/abstract=375784.

The profitability in option writing is related to the fact that option “implied volatility” is consistently higher than subsequently realized volatility. Implied volatility over the term of an option is inferred from its price using an options pricing model such as Black Scholes. Realized volatility is the actual volatility of the underlying asset over the same term that is subsequently observed. If the model is correctly pricing the option, the average difference between implied and realized volatility should be small over long periods of time.

It is well-known that implied volatility is consistently and significantly higher than realized volatility for many index options. See Stux and Fanelli (1990); Schneeweis and Spurgin (2001); Whaley (2002). This means that options prices are consistently higher than those inferred by the model. A strategy of writing options that have consistently high relative implied volatility could then earn a superior risk-adjusted return. Bondarenko (2003) finds that writing one-month at-the-money puts on S&P 500® futures has a Jensen's alpha of 23% per month (standard deviation 113%).

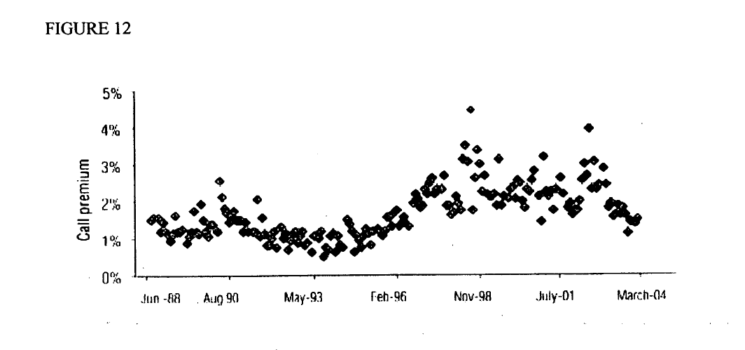

Over the period of this review, implied volatility averaged 16.53%, while realized volatility averaged 14.88%. The average difference of 1.64% is statistically greater than zero at the highest probability levels (p<1.2 10⁻⁶). Since the call premium is strongly positively related to implied volatility, the persistent greater than 10% excess implied volatility reflects a significant price premium to call writers. Call premiums are, of course, the key determinant of the improved example index performance. Over the period of this review call premium have averaged 1.69% a month with a standard deviation of 0.69%. Annualized, this translated to a 22.31% premium with a standard deviation of 2.86%. FIG. 12 displays monthly premium over the review period. The persistence and stability of the differential between implied and realized volatility is key to the continuation of the improved example index relative performance.

One proposed explanation for the high levels of relative implied volatility is the existence of a negative volatility risk premium (Bakshi, Cao, and Zhiwu “Do call prices and the underlying stock always move in the same direction?” 13 Review of Financial Studies 549 (2000); Bakshi and Kapadia “Volatility Risk Premiums Embedded in Individual Equity Options: Some New Insights,” Journal of Derivatives, 45-54 (Fall 2003); Bondarenko, “Market Price of Variance Risk and Performance of Hedge Funds,” Chicago: University of Illinois at Chicago (2004)). This would mean, essentially, that people are willing to pay to hold volatility. This might be the case, for example, if volatility is desirable to hold because it is negatively correlated with market returns.

Bondarenko (2004) notes that many hedge fund strategies are considered to be “short volatility” strategies. He finds that treating volatility as a priced risk factor and adding it to factor pricing models of hedge fund performance greatly increases the explanatory power of these models and reduces the risk-adjusted return of most hedge fund strategies. These results are consistent with a negative volatility risk premium. Statistical tests of the hypothesis of a negative volatility risk premium are inconclusive at this time. See Branger and Schlag, Can tests based on option hedging errors correctly identify volatility risk premia? (2004) Frankfurt am Main: Goethe University.

A perhaps simpler perspective for thinking about options prices is the supply and demand for optionality. This perspective is similar to the Ibbotson, Diermeier, and Siegel approach to the supply and demand for asset returns. Ibbotson, Diermeier, and Siegel “The demand for capital market returns: A new equilibrium theory,” 40 Financial Analyst Journal 22 (1984). In the options context, this framework is simply the proposition that the demand for the call option to participate in market upswings is high relative to the willingness of call writers to supply this optionality (and similarly for the demand for put to protect against market downturns). This perspective finds support from Bollen and Whaley (2004), who find that an option's implied volatility at a point in time is significantly affected by the net demand for the option.

Bollen and Whaley (2004) document what might be called clientele effects. For example, the departures from Black Scholes pricing are different for index options as compared to options on individual stocks, and these differences cannot be reasonably explained by the difference in the distributional properties of the returns. For example, they find that institutional demand for insurance in the form of far out-of-the-money S&P 500® index puts drives up the associated implied volatilities.

Bollen and Whaley (2004), however, do not address long-term determinants of the supply and demand for optionality. The buyers of call options have optimistic expectations of future performance. One possible explanation for the relative performance of the covered call strategy is that call buyers systematically overestimate the value of the call. Overestimating call value is consistent with overconfidence and confirmatory bias, two well documented behavioral tendencies. See Rabin, “Psychology and economics,” 36 Journal of Economic Literature 11 (1998).

Call purchasers are among the most confident of all investors. Their purchase will expire worthless unless the strike price is hit. Call purchasers often have strong expectations of future economic performance and are looking for leveraged investment performance. Behavioral research demonstrates that the more confident people are, the more likely they are to discount evidence contrary to their beliefs. The most confident investors are thus those who may be expected to have the most biased expectations.

The behavioral economist might then logically expect to see consistent pricing pressure in the direction of the observed upward bias in implied volatility. A mirror argument to that made for call purchasers can be made for put purchasers. The consequence of these observations is that the effects of any heterogeneity in investor expectations should be expected to be amplified in options markets relative to asset markets generally. If this behavioral explanation for observed options prices is indeed correct, part of the return of the improved example index is the monetization of this overconfidence bias.

One feature of the improved example index is that it is based on short-dated options. One reason for this is the time decay property of options, also known as theta. The closer an option comes to expiration, the less valuable it becomes, other factors being equal. Further, the closer an option comes to expiration, the more quickly its time value decays. See Hull, “Options, Futures, and other Derivatives,” New Jersey: Prentice Hall (4th ed., 2000) (who provides a systematic treatment of option theory). Because of this, the expected total premium from writing 12 consecutive at-the-money one-month calls is approximately twice the expected premium from writing four consecutive at-the-money three-month calls, other factors being equal.

The strong risk-adjusted performance of the improved example index is consistent with recent findings regarding options prices more generally. The persistent observed high relative implied volatility for index options and the hypothesized negative volatility risk premium are two potential explanations for observed out-performance. These explanations are complementary with the idea that options markets should be more sensitive to heterogeneity in investor views and, thus, to biases due to fear and overconfidence. To the degree that fundamental considerations such as these do explain the improved example index's relative performance, such out performance should be expected to continue in the future.

Thus, it is seen that the improved example index, a benchmark for an S&P 500® index based covered call strategy, had slightly higher returns and significantly less volatility than the S&P 500® index over a time period of almost 16 years, despite the fact that covered calls have a truncated upside in the short term. The improved example index is found to have been an effective substitute for large-cap investment that improved the risk-adjusted performance of standard investment portfolios, and that it is reasonable to conclude that investable versions would have substantially replicated the performance of the index. It is also determined that the improved example index would still have been a very desirable investment when its return was reduced by 100 basis points. Further, several fundamental considerations have been identified that might explain the relative performance of the improved example index. These conclusions, together with the likelihood that any changes in the relative performance of the improved example index will evolve slowly over time, lead to the assessment that the improved example index is a prudent investment option worthy of investor attention.

### EXAMPLE 1(C)

### Tax Advantage BXM

In an additional embodiment in accordance with the present invention, an improved index was designed to reflect on a portfolio that invests in Standard & Poor's® 500 index stocks that also sells S&P 500® index covered call options (SPX). This second index is substantially the same as the first two example indexes, with an improvement to the tax treatment that would accrue to a financial product based thereon. Thus, this third index likewise measures the total rate of return of a hypothetical “covered call” strategy applied to the S&P 500® index. So also, this third index consists of a hypothetical portfolio consisting of a “long” position indexed to the S&P 500® index on which are deemed sold a succession of one-month, at-the-money call options on the S&P 500® index listed on the Chicago Board Options Exchange (CBOE). This third index provides a benchmark measure of the total return performance of this hypothetical portfolio. This third index is based on the cumulative gross rate of return of the covered S&P 500® index based on the historical return series beginning Jun. 1, 1988, the first day that Standard and Poor's began reporting the daily cash dividends for the S&P 500® index.

Each S&P 500® index call option in the hypothetical portfolio is held to the third Wednesday of the month instead of to maturity. As a result, strategy calls for buying back the old call at the same time as one sells the new call (versus letting the old call expire). The strike price of the new call option can be the S&P 500® index call option listed on the CBOE with the closest strike price above the last value of the S&P 500® index reported at the close of the preceding Tuesday. For example, if the last S&P 500® index value reported at the close of the preceding Tuesday is 901.10 and the closest listed S&P 500® index call option strike price above 901.10 is 905, then the 905 strike S&P 500® index call option is selected as the new call option to be incorporated into the index. If the last value of the S&P 500® index reported at the close of the preceding Tuesday is exactly equal to a listed S&P 500® index call option strike price, then the new call option can be the S&P 500® index call option with that exact at-the-money strike price. The long S&P 500® index component and the short call option component are held in equal notional amounts, i.e., the short position in the call option is “covered” by the long S&P 500® index component.

Once the strike price of the new call option has been identified, the new call option can be deemed sold at a price equal to the VWAP of the new call option during the half-hour period beginning at 8:30 a.m. (Eastern Time). Similarly, the price at which the old option is deemed bought back is the VWAP of this option during the half-hour period beginning at 8:30 a.m. (Eastern Time). In this third embodiment, the VWAP is derived in a two-step process. First, trades in the call option between 8:30 a.m. and 9:00 a.m. (Eastern Time) that are identified as having been executed as part of a “spread” are excluded. Then the weighted average of all remaining transaction prices of the call option between 8:30 a.m. and 9:00 a.m. (Eastern Time) are calculated, with weights equal to the fraction of total non-spread volume transacted at each price during this period. The source of the transaction prices used in the calculation of the VWAP is CBOE's MDR System. If no transactions occur in the call option between 8:30 a.m. and 9:00 a.m. (Eastern Time), then if the call option is a new call option, the call option can be deemed sold at the last bid price reported before 9:00 a.m. (Eastern Time); if the call option is a old call option, then the old call option can be deemed bought at the last ask price reported before 9:00 a.m. (Eastern Time). The value of option premium deemed received from the new call option can be functionally “re-invested” in the portfolio.

The improved example index can be calculated once per day at the close of trading for the respective components of the covered S&P 500® index. The example index can be a chained index, with its value equal to 100 times the cumulative product of gross daily rates of return of the covered S&P 500® index since the inception date of the index. On any given day, the example index (BXM) can be calculated as follows:
BXMₜ=BXMₜ₋₁(1+Rₜ)
where Rₜ is the daily rate of return of the covered S&P 500® index. This rate includes ordinary cash dividends paid on the stocks underlying the S&P 500® index that trade “ex-dividend” on that date.

On each trading day excluding roll dates, the daily gross rate of return of the index equals the change in the value of the components of the covered S&P 500® index, including the value of ordinary cash dividends payable on component stocks underlying the S&P 500® index that trade “ex-dividend” on that date, as measured from the close in trading on the preceding trading day. The gross daily rate of return (1+Rₜ) can be equal to:
1+Rₜ=(Sₜ+Divₜ−Cₜ)/(Sₜ₋₁−Cₜ₋₁)
where Sₜ is the closing value of the S&P 500® index at date t; Sₜ₋₁ is the closing value of the S&P 500® index on the preceding trading day; Divₜ represents the ordinary cash dividends payable on the component stocks underlying the S&P 500® index that trade “ex-dividend” at date t expressed in S&P 500® index points; Cₜ is the arithmetic average of the last bid and ask prices of the call option reported before 4:00 p.m. (Eastern Time) on the roll date; and Cₜ₋₁ is the average of the last bid and ask prices of the call option reported before 4:00 p.m. (Eastern Time) on the preceding trading day.

On roll dates, the gross daily rate of return can be compounded from: the gross rate of return from the previous close to 9:00 a.m. (Eastern Time) and the gross rate of return from the time the new call option can be deemed sold (9:00 a.m. (Eastern Time)) to the close of trading on the roll date, expressed as follows:
1+Rₜ(1+Rₐ)×(1+R_{b})
where:
1+Rₐ=(S^{VWAV1}+Divₜ−C^{old}_{VWAP}) /(Sₜ₋₁−Cₜ₋₁);
   and
1+R_{b}=(Sₜ−Cₜ)/(S^{VWAV2}−C^{new}_{VWAP})
   where Rₐ is the rate of return of the covered S&P 500® index from the previous close of trading through 9:00 a.m.; R_{b} is the rate of return of the un-covered S&P 500® index from 9:00 a.m. to the close of trading on the roll date; C^{old}_{VWAP} is the volume-weighted average trading price of the old call option between 8:30 a.m. and 9:00 a.m. (Eastern Time); C^{new}_{VWAP} is the volume-weighted average price of the new call option between 8:30 a.m. and 9:00 a.m. (Eastern Time); S^{VWAV1} is the volume-weighted average value of the S&P 500® index based on the same time used to calculate the VWAP in the old call option; and S^{VWAV2} is the volume-weighted average price of the S&P 500® index based on the same times used to calculate the VWAP of the new call option. As previously defined, Divₜ represents dividends on S&P 500® index component stocks determined in the same manner as on non-roll dates; Sₜ is the closing value of the S&P 500® index at date t; Sₜ₋₁ is the closing value of the S&P 500® index on the preceding trading day; Cₜ is the arithmetic average of the last bid and ask prices of the call option reported before 4:00 p.m. (Eastern Time) on the roll date; and Cₜ₋₁ is the average of the last bid and ask prices of the call option reported before 4:00 p.m. (Eastern Time) on the preceding trading day. Sₜ₋₁ and Cₜ₋₁ are determined in the same manner as on non-roll dates.

Thus, this improved index in accordance with the present invention meets the definition of a “qualified covered call” under the Internal Revenue Code. Because under this improved index of the present invention the new call will always be written at least thirty (30) days prior to when the call will expire and is not based on cash-settled option, this improved index is more tax-efficient because it meets the definition of a “qualified covered call” under the Internal Revenue Code, §1092(c)(4). Qualified covered calls (QCC) are exempt from the IRS's straddle rules and thus are given more favorable tax treatment.

### Leveraged Fund

In accordance with the present invention, an index and financial product can be created by leveraging an index of the present invention to take on more risk while delivering an even greater return. In order to leverage the index of the present invention, the proportions of the long position in the equity (for example, stock) index and the short position in a call option for that equity index and adjusted to the desired level of risk. Once again, as with the indexes described above, a leveraged index and financial product in accordance with the principals of the present invention is preferable embodied as a system cooperating with computer hardware components and as a computer implemented method, as known in the art.

### EXAMPLE 2

### Leveraged Fund

For example, in the Example 1 embodiments of the present invention it was seen that by utilizing the present invention an index and financial product are created that surprisingly produced a monthly return approximately equal to the S&P 500® index portfolio, but at less than 65% of the risk of the S&P 500® index (i.e., 2.663% vs. 4.103%). The index of Example 1 could be leveraged to take on a risk approximately equal to the risk of the S&P 500® index (i.e., 4.103%) instead of the Example 1 index risk (i.e. 2.663%). In order to leverage the index of Example 1, the long exposure to the Standard & Poor's® 500 index would comprise both stocks and a long position in either S&P 500® index futures or S&P 500® index option “combos” (i.e., long calls and short puts with the same strike price and expiration date), while the short position in the S&P 500® index covered call options (SPX) would be increased. In particular, in order to achieve a risk approximately equal to the risk of the S&P 500® index (i.e., 4.103%), a leveraged portfolio can be constructed that would hold an S&P 500® stock position and an S&P 500® futures/SPX option combo position, such that the exposure due to the stock position would be approximately twice that of the S&P 500® futures/SPX option combo position. The leveraged portfolio would also hold a short position in SPX options covering the combined (stock and futures/combos) long S&P 500® position. The mechanics of the leveraged index would be similar to the Example 1 index, but would be changed to reflect the returns due to the leveraged portion of the portfolio.

It should be understood that various changes and modifications preferred in to the embodiment described herein would be apparent to those skilled in the art. For example, additional financial instruments based on the financial instruments of the present invention such as exchange traded funds are to be considered within the scope of the present invention. Such changes and modifications can be made without departing from the spirit and scope of the present invention and without demising its attendant advantages. It is therefore intended that such changes and modifications be covered by the appended claims.

What is claimed is:

1. A financial instrument for measuring the performance of a covered call strategy comprising:
creating an underlying asset portfolio;
writing a nearby call option against the underlying asset portfolio;
settling the call option against a calculation of a financial instrument compiled from the opening prices of component assets underlying the financial instrument; and
writing a new nearby call option against the underlying asset portfolio.

2. The financial instrument of claim 1 further including performing the calculation when all components underlying the financial instrument have opened for trading.

3. The financial instrument of claim 1 further including valuing the call option at a price equal to the volume-weighted average of the traded prices of the call option.

4. The financial instrument of claim 3 further including deriving the volume-weighted average of the traded prices of the call option excluding trades that are identified as having been executed as part of a “spread” and calculating the weighted average of all remaining transaction prices of the new call option, with weights equal to the fraction of total non-spread volume transacted at each price during this period.

5. The financial instrument of claim 1 further including functionally reinvesting the value of option premium deemed received from the new call option in the portfolio.

6. The financial instrument of claim 1 further including rolling the call.

7. The financial instrument of claim 1 further including calculating the financial instrument (BXM) in accordance with:
BXMₜ=BXMₜ₋₁(1+Rₜ)
where Rₜ is the daily rate of return of the portfolio.

8. The financial instrument of claim 1 further wherein the call option is cash-settled.

9. The financial instrument of claim 1 wherein the call option comprises a basket of call options.

10. The financial instrument of claim 1 wherein the call option is selected from the group comprising securities, commodities, indexes, economic indicators, and combinations thereof.

11. The financial instrument of claim 1 wherein an underlying asset is selected from the group comprising securities, commodities, indexes, economic indicators, and combinations thereof.

12. The financial instrument of claim 1 further wherein the financial instrument is an index.

13. The financial instrument of claim 1 further wherein the financial instrument is an exchange traded fund.

14. The financial instrument of claim 1 further including leveraging the financial instrument by adjusting to the desired level of risk the proportions of a long position in the underlying asset and a short position in the call options for that asset.

15. A financial instrument for measuring the performance of a covered call strategy comprising:
creating an underlying asset portfolio;
writing a nearby call option against the underlying asset portfolio;
valuing the call option at a price equal to the volume-weighted average of the traded prices of the call option.

16. The financial instrument of claim 15 further including settling the call option against a calculation of the financial instrument compiled from the opening prices of component assets underlying the financial instrument.

17. The financial instrument of claim 15 further including deriving the volume-weighted average of the traded prices of the call option excluding trades that are identified as having been executed as part of a “spread” and calculating the weighted average of all remaining transaction prices of the new call option, with weights equal to the fraction of total non-spread volume transacted at each price during this period.

18. The financial instrument of claim 15 further including functionally reinvesting the value of option premium deemed received from the new call option in the portfolio.

19. The financial instrument of claim 15 further including rolling the call.

20. The financial instrument of claim 15 further including calculating the financial instrument (BXM) in accordance with:
BXMₜ=BXMₜ₋₁(1+Rₜ)
where Rₜ is the daily rate of return of the portfolio.

21. The financial instrument of claim 15 further wherein the call option is cash-settled.

22. The financial instrument of claim 15 wherein the call option comprises a basket of call options.

23. The financial instrument of claim 15 wherein the call option is selected from the group comprising securities, commodities, indexes, economic indicators, and combinations thereof.

24. The financial instrument of claim 15 wherein an underlying asset is selected from the group comprising securities, commodities, indexes, economic indicators, and combinations thereof.

25. The financial instrument of claim 15 further wherein the financial instrument is an index.

26. The financial instrument of claim 15 further wherein the financial instrument is an exchange traded fund.

27. The financial instrument of claim 15 further including leveraging the financial instrument by adjusting to the desired level of risk the proportions of a long position in the underlying asset and a short position in the call options for that asset.

28. A financial instrument for measuring the performance of a covered call strategy comprising:
creating an underlying asset portfolio;
writing a nearby call option against the underlying asset portfolio a sufficient period of time such that the financial instrument is a “qualified covered call” under the Internal Revenue Code; and
the call option is not cash-settled.

29. The financial instrument of claim 28 including writing a nearby call option against the underlying asset portfolio at least thirty (30) days prior to when the call will expire.

30. The financial instrument of claim 28 further including calculating the financial instrument (BXM) in accordance with:
BXMₜ=BXMₜ₋₁(1+Rₜ)
where Rₜ is the daily rate of return of the portfolio.

31. The financial instrument of claim 28 wherein the call option comprises a basket of call options.

32. The financial instrument of claim 28 wherein the call option is selected from the group comprising securities, commodities, indexes, economic indicators, and combinations thereof.

33. The financial instrument of claim 28 wherein an underlying asset is selected from the group comprising securities, commodities, indexes, economic indicators, and combinations thereof.

34. The financial instrument of claim 28 further wherein the financial instrument is an index.

35. The financial instrument of claim 28 further wherein the financial instrument is an exchange traded fund.

36. The financial instrument of claim 28 further including leveraging the financial instrument by adjusting to the desired level of risk the proportions of a long position in the underlying asset and a short position in the call options for that asset.

37. A financial instrument comprising basing the financial instrument on a return of a portfolio consisting of an underlying asset and options on that underlying asset.

38. The financial instrument of claim 37 further wherein the options are call options

39. The financial instrument of claim 38 further wherein the options are out-of-the-money call options.

40. The financial instrument of claim 38 further wherein the options comprise a succession of out-of-the-money call options.

41. The financial instrument of claim 38 further including valuing the call option at a price equal to the volume-weighted average of the traded prices of the call option.

42. The financial instrument of claim 38 further wherein the call option is cash-settled.

43. The financial instrument of claim 38 wherein the call option comprises a basket of call options.

44. The financial instrument of claim 38 wherein the call option is selected from the group comprising securities, commodities, indexes, economic indicators, and combinations thereof.

45. The financial instrument of claim 37 wherein an underlying asset is selected from the group comprising securities, commodities, indexes, economic indicators, and combinations thereof.

46. The financial instrument of claim 37 further wherein the options are put options.

47. The financial instrument of claim 46 further wherein the options are at-the-money put options.

48. The financial instrument of claim 46 further wherein the options comprise a succession of at-the-money put options.

49. The financial instrument of claim 37 further wherein the options comprise a succession of out-of-the-money put options and a succession of out-of-the-money call options.

50. The financial instrument of claim 37 further wherein the financial instrument is an index.

51. The financial instrument of claim 37 further wherein the financial instrument is an exchange traded fund.

52. The financial instrument of claim 37 further including leveraging the financial instrument by adjusting to the desired level of risk the proportions of a long position in the underlying asset and a short position in the options for that asset.

53. A financial instrument comprising:
measuring the performance of a covered call strategy by selling call options on an underlying asset; and
leveraging the financial instrument by adjusting to the desired level of risk the proportions of a long position in the underlying asset and a short position in the call option for that asset.

54. The financial instrument of claim 53 further including selling at-the-money call options on an underlying asset.

55. The financial instrument of claim 53 further including selling out-of-the-money call options on an underlying asset.

56. The financial instrument of claim 53 further including holding a stock index portfolio and selling a succession of at-the-money call options on the stock index.

57. The financial instrument of claim 53 further including holding a stock index portfolio and selling a succession of out-of-the-money call options on the stock index.

58. The financial instrument of claim 57 further wherein the out-of-the-money call options comprise one-month out-of-the-money call options.

59. The financial instrument of claim 57 further wherein the out-of-the-money call options comprise 5% out-of-the-money call options.

60. The financial instrument of claim 53 further including rolling the call.

61. The financial instrument of claim 53 further including calculating the index (CCI) in accordance with:
CCIₜ=CCIₜ₋₁(1+Rₜ)
where Rₜ is the daily rate of return of the portfolio.

62. The financial instrument of claim 53 further wherein the financial instrument is an index.

63. The financial instrument of claim 53 further wherein the financial instrument is an exchange traded fund.
